(19) United States
(12) Patent Application Publication
(10) Pub. No.: US 2026/0239003 A1
(43) Pub. Date: Aug. 13, 2026

(54) Reuse of Security Context for Non-Seamless Wireless LAN Offload

(71) Applicant: Telefonaktiebolaget LM Ericsson (publ), Stockholm (SE)

(72) Inventors: Vesa Lehtovirta, Jorvas (FI); Cheng Wang, Shanghai (CN); David Castellanos Zamora, Madrid (ES)

(21) Appl. No.: 19/149,992

(22) PCT Filed: Feb. 13, 2024
(86) PCT No.: PCT/IB2024/051326

§ 371 Date: Jul. 22, 2025

(30) Foreign Application Priority Data
Feb. 13, 2023 (WO) PCT/CN2023/075689

(51) Int. Cl. H04W 12/06; H04W 12/041; H04W 12/72; H04W 84/12

(52) U.S. Cl. CPC H04W 12/06; H04W 12/041; H04W 12/72; H04W 84/12

(57) ABSTRACT

A user equipment (UE) is configured to communicate with a communication network via a wireless local access network (WLAN). The UE performs an authentication with the communication network, including obtaining an identifier associated with user credentials on which the authentication is based. Subsequently, the UE sends, to the WLAN, a request for authorization to connect to the WLAN, wherein the request for authorization includes the identifier, wherein the identifier points to or will be routed to a WLAN offload function. The UE receives, from the communication network via the WLAN, an authorization to connect to the WLAN, wherein the authorization is based on the identifier, and the UE establishes a secure connection with the WLAN based on the received authorization.

### TECHNICAL FIELD

The present disclosure relates generally to communication networks. Certain embodiments relate more specifically to techniques for a user equipment (UE) to access a Wireless Local Area Network (WLAN) based on user credentials for a public land mobile network (PLMN, e.g., a 5G network).

### BACKGROUND

The fifth generation (“5G”) of cellular systems, also referred to as New Radio (NR), was initially standardized 3GPP Rel-15 and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (30D), and several other use cases. 5G/NR technology shares many similarities with fourth-generation LTE.

At a high level, the 5G System (5GS) comprises an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an example 5G network architecture, comprising a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 101, 151, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. The 5GC can include other network functions (NFs), as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, 39) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 120 and gNB-DUs 120 and 130. CUs (e.g., gNB-CU 120) are logical nodes that host higher-layer protocols and perform various gNB functions such controlling the operation of DUs. A DU (e.g., gNB-DUs 120, 230) is a decentralized logical node that hosts lower layer protocols and can include, depending on the functional split option, various subsets of the gNB functions. A gNB-CU connects to one or more gNB-DUs over respective 39 logical interfaces (e.g., 122 and 132).

One change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

3GPP has defined architectures to support UE accessing 5GC via trusted or untrusted non-3GPP access networks (e.g., WLAN). The architecture for trusted non-3GPP access to 5GC includes an interworking function (TWIF) that enables Non-5G-Capable over WLAN (N5CW) devices to access 5GC via trusted WLAN access networks. Additionally, 3GPP has defined an architecture that enables a UE to connect to a WLAN access network using its 5GS credentials without registration to 5GS. This architecture is based on the Non-Seamless WLAN Offload Function (NSWOF), which interfaces to the WLAN using the SWa interface as defined in 3GPP TS 23.402 (v17.0.0), and interfaces to an authentication server function (AUSF) in 5GC via the Nausf Service Based Interface (SBI).

### SUMMARY

In the current 3GPP specifications, if the UE initially registers in 5GC (e.g., via NG-RAN) and then decides to access a WLAN by performing NSWO access, the UE is unable to use the security arrangement setup during 5GC registration. In other words, UE authentication needs to be performed twice: first during 5GC registration and again during NSWO access.

These two UE authentications may occur near in time, which requires excessive signaling and processing in both UE and 5GC.

Embodiments of the present disclosure provide improved registration of UEs via non-3GPP access, such as by facilitating solutions to overcome example problems summarized above and described in more detail below.

Some embodiments include methods (e.g., procedures) for a UE configured to communicate with a communication network (e.g., 5GC) via a WLAN.

These example methods can include performing an authentication with the communication network, including obtaining an identifier associated with user credentials on which the authentication is based. These example methods can also include subsequently sending, to the WLAN, a request for authorization to connect to the WLAN. The request for authorization includes the identifier. These example methods can also include receiving, from the communication network via the WLAN, an authorization to connect to the WLAN. The authorization is based on the identifier. These example methods can also include establishing a secure connection with the WLAN based on the received authorization.

In various embodiments, the identifier associated with user credentials is one of the following: a temporary UE identifier assigned by the communication network (e.g., 5G-GUTI), a security key identifier derived by the UE (e.g., Kausf ID), or a concealed identifier of a user subscription to the communication network (e.g., SUCI).

Other embodiments include methods (e.g., procedures) for an NSWOF associated with a communication network (e.g., 5GC).

These example methods can include receiving, from a UE via a WLAN, a request for authorization for the UE to connect to the WLAN. The request for authorization includes an identifier associated with user credentials for the communication network. These example methods can also include sending, to a network node or function (NNF) of the communication network, a request for UE authentication that includes the identifier or a representation thereof. These example methods can also include receiving, from the NNF, an authorization for the UE to connect to the WLAN, wherein the authorization is based on the identifier. These example methods can also include forwarding the authorization to the WLAN and to the UE via the WLAN.

In some embodiments, the NNF is an access and mobility management function (AMF). In other embodiments, the NNF is an authorization server function (AUSF).

Other embodiments include methods (e.g., procedures) for an AMF associated with a communication network (e.g., 5GC).

These example methods can include receiving, from an NSWOF associated with the communication network, a request for authorization of a UE for access to a WLAN. The request includes an identifier associated with user credentials for the communication network. These example methods can also include, based on the identifier, discovering a valid UE security context stored in the communication network. These example methods can also include, based on the discovered UE security context, sending to the NSWOF an authorization for the UE to connect to the WLAN.

Other embodiments include methods (e.g., procedures) for an AUSF associated with a communication network (e.g., 5GC).

These example methods can include receiving, from an NSWOF associated with the communication network, a request for authorization of a UE for access to a WLAN. The request includes an identifier associated with user credentials for the communication network. These example methods can also include, based on the identifier, discovering a valid UE security key stored in the communication network. These example methods can also include, based on the discovered UE security key, sending to the NSWOF an authorization for the UE to connect to the WLAN.

Other embodiments include UEs (e.g., wireless devices), NSWOFs, AMFs, and AUSFs (or network nodes hosting and/or implementing these functions) configured to perform operations corresponding to any of the example methods described herein. Other embodiments include non-transitory, computer-readable media storing program instructions that, when executed by processing circuitry, configure such UEs, NSWOFs, AMFs, and AUSFs (or network nodes hosting and/or implementing these functions) to perform operations corresponding to any of the example methods described herein.

These and other embodiments described herein can provide various benefits and/or advantages. For example, since only one authentication procedure is needed for a UE, this can reduce the signaling between UE and involved network entities (and among network entities), as well as processing load in UE and involved network entities, relative to conventional techniques that require two authentication procedures. Additionally, embodiments facilitate reduced delay when a UE registers to non-3GPP access network since the UE's security context is already available from earlier registration with 5GC.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an example 5G/NR network architecture.

FIG. 2 shows an example non-roaming reference architecture of a 5GC.

FIGS. 3-4 show example non-roaming architectures for 5GC with untrusted and trusted non-3GPP access by UEs, respectively.

FIG. 5 shows an example non-roaming architecture for N5CW device access via trusted WLAN.

FIG. 6 shows a 3GPP-defined architecture that enables a UE to connect to a WLAN using its 5GS credentials without registration to 5GS.

FIG. 7 shows a signaling diagram of an authentication procedure for untrusted, non-3GPP access to 5GC.

FIG. 8 (which includes FIGS. 8A-C) shows a signaling diagram of a procedure for authentication and PDU session establishment via trusted, non-3GPP access to 5GC.

FIG. 9 (which includes FIGS. 9A-B) shows a signaling diagram of an authentication procedure for N5CW devices that access 5GC via trust WLAN.

FIG. 10 shows a signaling diagram of an authentication procedure for non-seamless WLAN offload (NSWO) in 5GC.

FIG. 11 shows an example non-roaming architecture for 5GC with untrusted non-3GPP access by UEs, according to various embodiments of the present disclosure.

FIGS. 12-16 show signaling diagrams for various authentication procedures for NSWO in 5GS, according to various embodiments of the present disclosure.

FIG. 17 shows an example method (e.g., procedure) for a UE, according to various embodiments of the present disclosure.

FIG. 18 shows an example method (e.g., procedure) for an NSWOF, according to various embodiments of the present disclosure.

FIG. 19 shows an example method (e.g., procedure) for an AMF, according to various embodiments of the present disclosure.

FIG. 20 shows an example method (e.g., procedure) for an AUSF, according to various embodiments of the present disclosure.

FIG. 21 shows a communication system according to various embodiments of the present disclosure.

FIG. 22 shows a UE according to various embodiments of the present disclosure.

FIG. 23 shows a network node according to various embodiments of the present disclosure.

FIG. 24 shows host computing system according to various embodiments of the present disclosure.

FIG. 25 is a block diagram of a virtualization environment in which functions implemented by some embodiments of the present disclosure may be virtualized.

FIG. 26 illustrates communication between a host computing system, a network node, and a UE via multiple connections, at least one of which is wireless, according to various embodiments of the present disclosure.

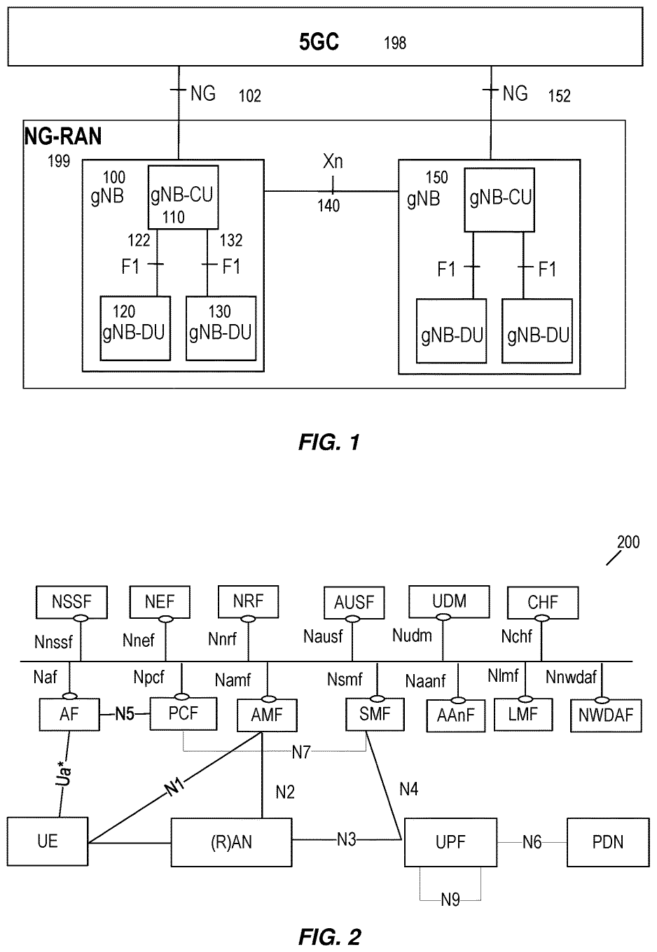

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:

Radio Node: As used herein, a “radio node” can be either a “radio access node” or a “wireless device.”

Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP Fifth Generation (5G) NR network or an enhanced or evolved Node B (eNB/ng-eNB) in a 3GPP LTE network), base station distributed components (e.g., CU and DU), base station control-and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.

Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.

Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).

Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

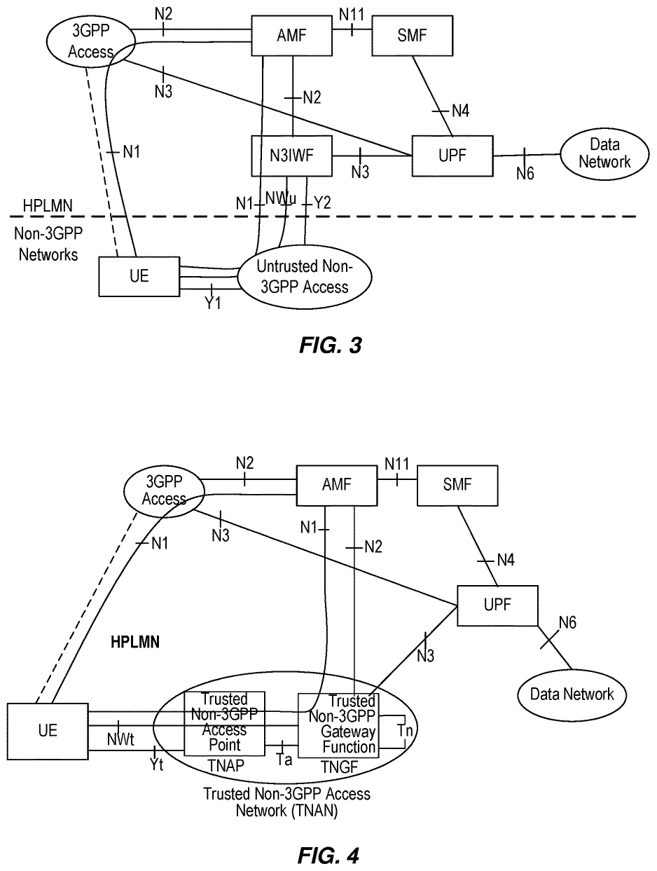

FIG. 2 shows an example non-roaming reference architecture of a 5GC (200), with service-based interfaces and various 3GPP-defined NFs. These include the following NFs, with additional details provided for those most relevant to the present disclosure:

Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.

Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.

User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.

Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.

Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.

Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.

Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In general, NEF provides services similar to services provided by SCEF in EPC.

Network Repository Function (NRF) with Nnrf interface—provides service registration and discovery, enabling NFs to identify appropriate services available from other NFs.

Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.

Authentication Server Function (AUSF) with Nausf interface—based in a user's home network (HPLMN), it performs user authentication and computes security key materials for various purposes.

Network Data Analytics Function (NWDAF) with Nnwdaf interface, described in more detail above and below.

Location Management Function (LMF) with NImf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. The terms “UDM” and “UDM function” are used interchangeably herein.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Service Communication Proxy (SCP) is a 5GC NF that was introduced in Rel-16. SCP provides centralized capabilities such as service-based interface (SBI) routing, NF discovery and selection, failover, message screening, etc. More generally, SCP facilitates 5GC implementation in a highly distributed multi-access edge compute cloud environment. SCP provides a single point of entry for a cluster of NFs after they have been successfully discovered by the NRF. As such, the SCP becomes the delegated discovery point in a data center, offloading NRF from the distributed service meshes that can comprise a network operator's infrastructure.

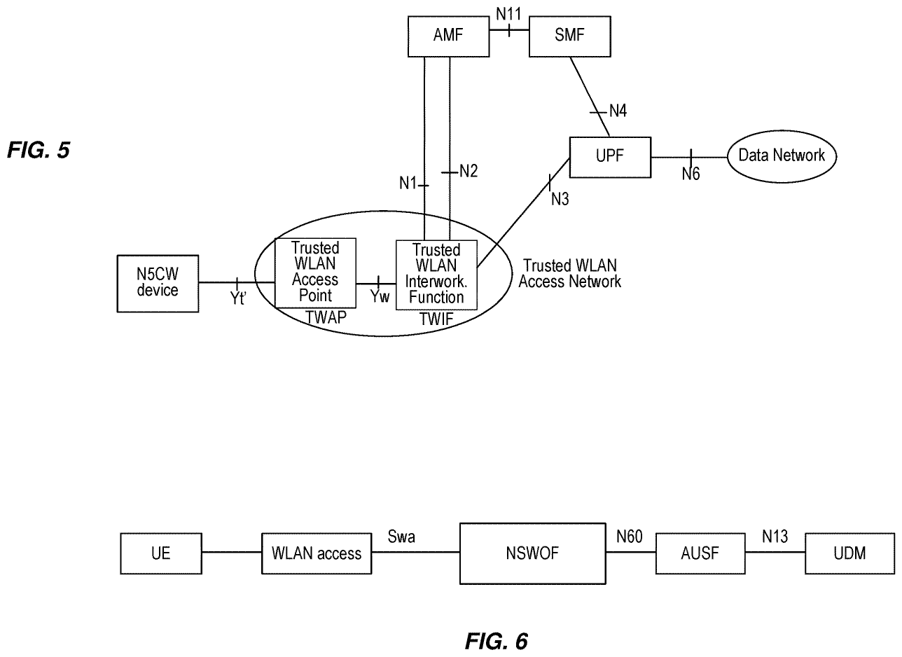

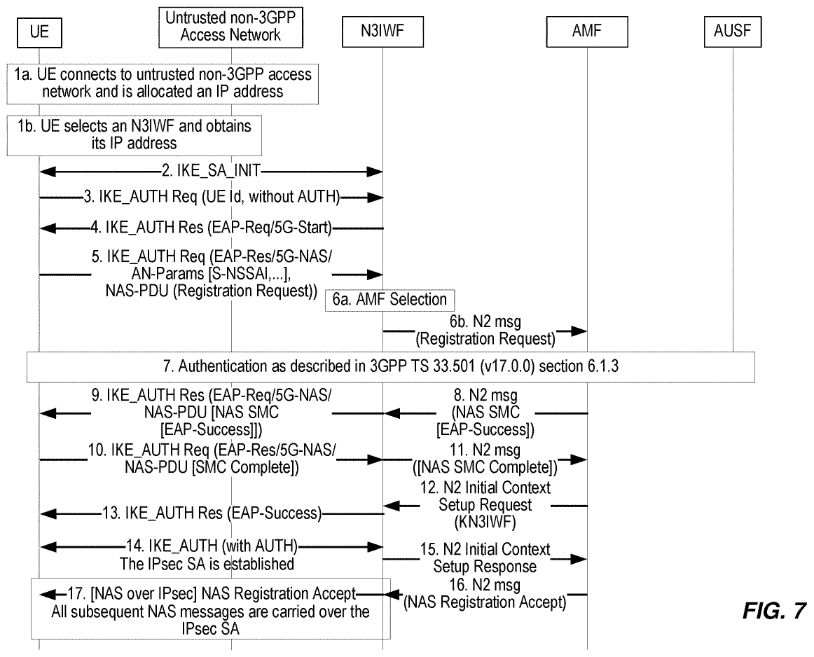

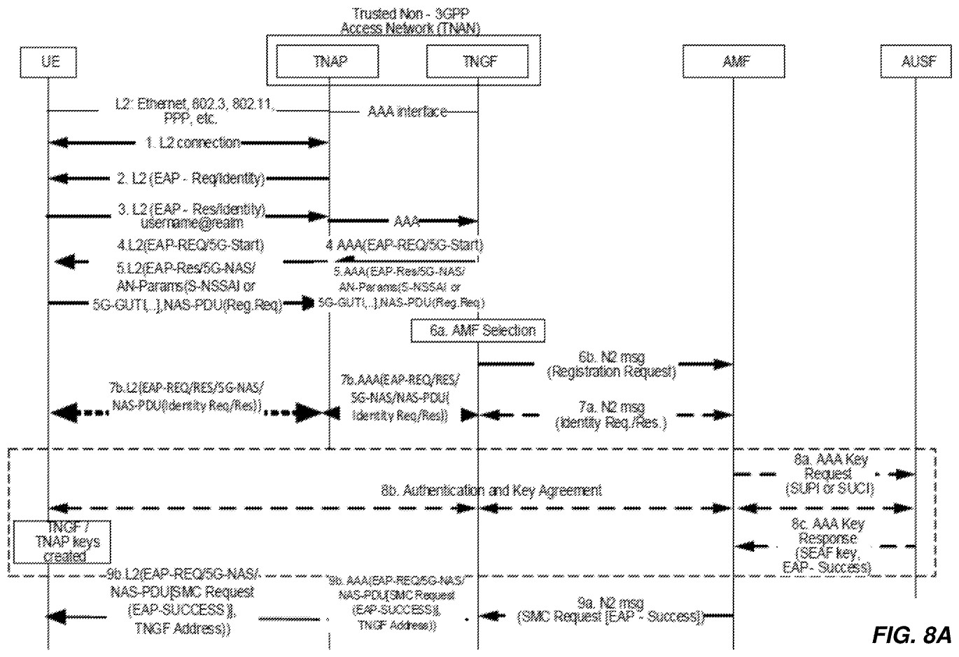

As briefly mentioned above, 3GPP has defined architectures to support UE accessing 5GC via trusted or untrusted non-3GPP access networks (e.g., WLAN). FIGS. 3 and 4 show example non-roaming architectures for 5GC with untrusted and trusted non-3GPP access by UEs, respectively. 3GPP has also defined an interworking function (called TWIF) that enables Non-5G-Capable over WLAN (N5CW) devices to access 5GC via trusted WLAN access networks. FIG. 5 shows an example non-roaming architecture for N5CW device access via trusted WLAN, which includes the TWIF mentioned above. Further details of the example architectures shown in FIGS. 3-5 are given in 3GPP TS 23.501 (v17.4.0).

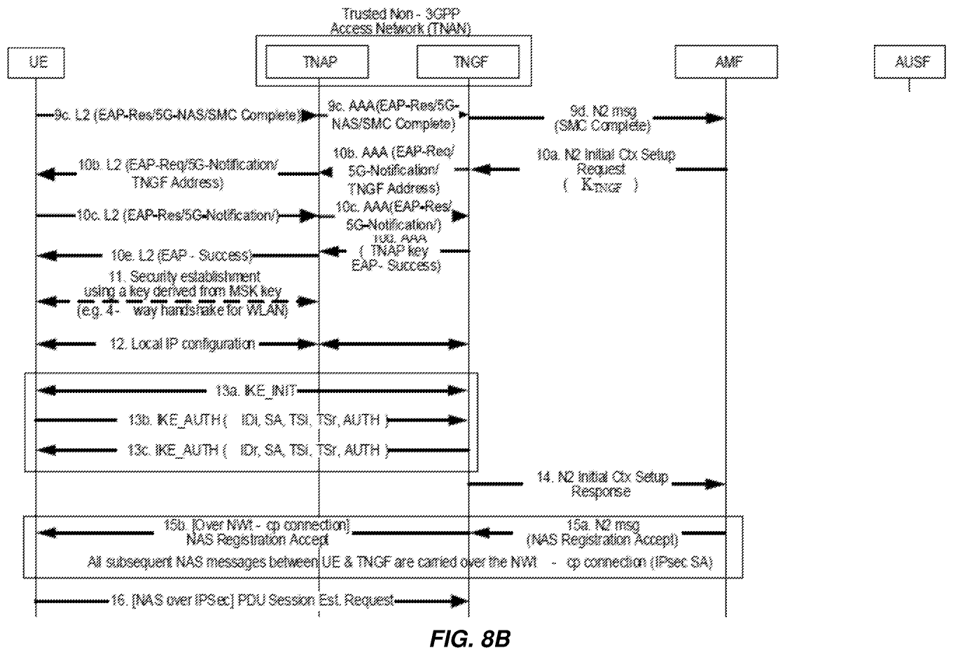

Additionally, FIG. 6 shows a 3GPP-defined architecture that enables a UE to connect to a WLAN using its 5GS credentials without registration to 5GS, which is further defined in 3GPP document S2-2203254. This architecture is based on the Non-Seamless WLAN Offload Function (NSWOF), which interfaces to the WLAN using the Sea interface as defined in 3GPP TS 23.402 (v17.0.0) and to an authentication server function (AUSF) in 5GC via the Nausf Service Based Interface (SBI). The functionality of NSWOF and the procedures applied for supporting WLAN connection using 5GS credentials for Non-seamless WLAN offload (NSWO) are further defined in 3GPP TS 33.501 (v17.5.0) Annex S. Note that 5G NWSO is not applicable to standalone non-public networks (SNPN).

The UE can also connect to a WLAN access network using 5GS credentials by performing the 5GS registration via trusted non-3GPP access procedure defined in 3GPP TS 23.502 (v17.5.0) section 4.12a.2.2. With this procedure, the UE connects to a WLAN access network using 5GS credentials and simultaneously registers in 5GS. However, the architecture shown in FIG. 6 enables a UE to connect to a WLAN access network using 5GS credentials but without registration in 5GS.

If the WLAN is configured as Untrusted Non-3GPP access but supports IEEE 802.1x, 5G NSWO may be used to access the WLAN. Any time after the UE obtains the connection to WLAN network and the local IP address, the UE may initiate Untrusted Non-3GPP Access to obtain the access to 5GC.

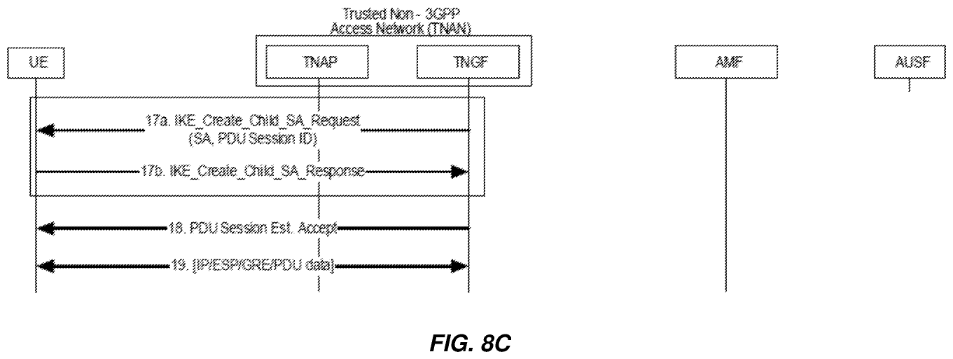

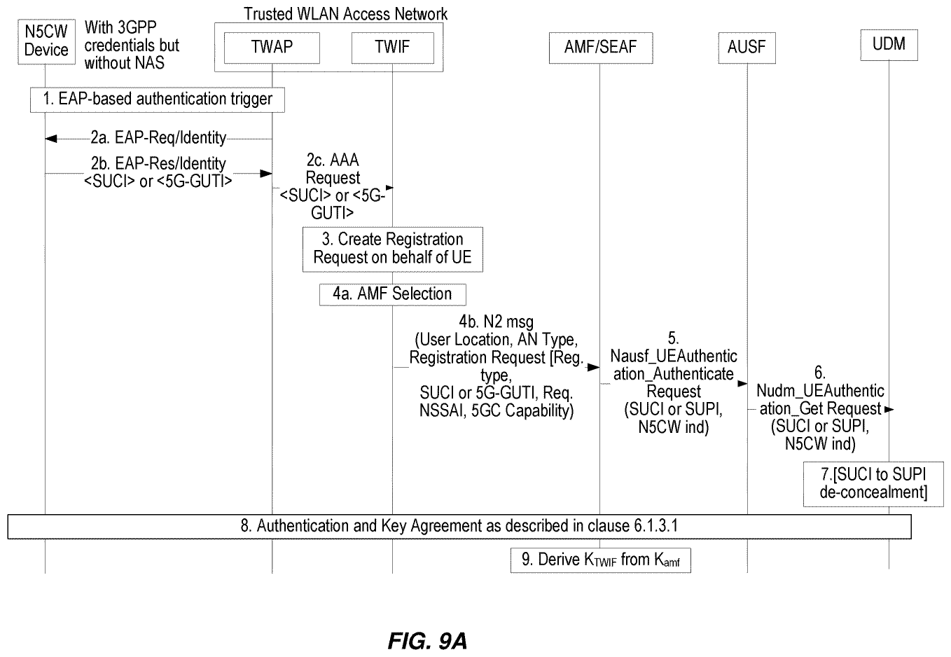

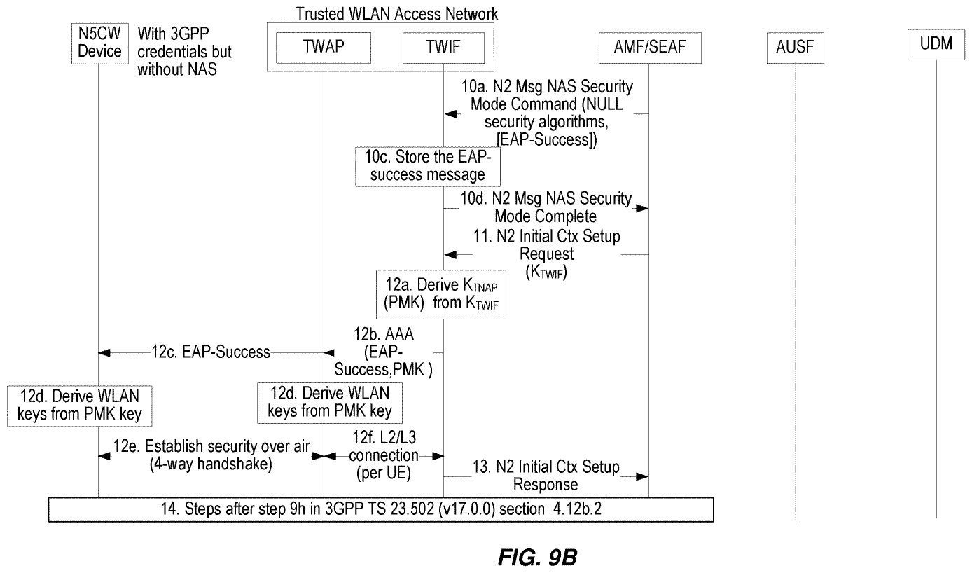

FIG. 7 shows a signaling diagram of an authentication procedure for untrusted, non-3GPP access to 5GC. FIG. 8 (which includes FIGS. 8A-C) shows a signaling diagram of a procedure for authentication and PDU session establishment via trusted, non-3GPP access to 5GC. Likewise, FIG. 9 (which includes FIGS. 9A-B) shows a signaling diagram of an authentication procedure for N5CW devices that access 5GC via trusted WLAN access. These procedures are further specified in 3GPP TS 33.501 (v17.5.0) sections 7.2.1, 7A.2.1, and 7A.2.4, respectively.

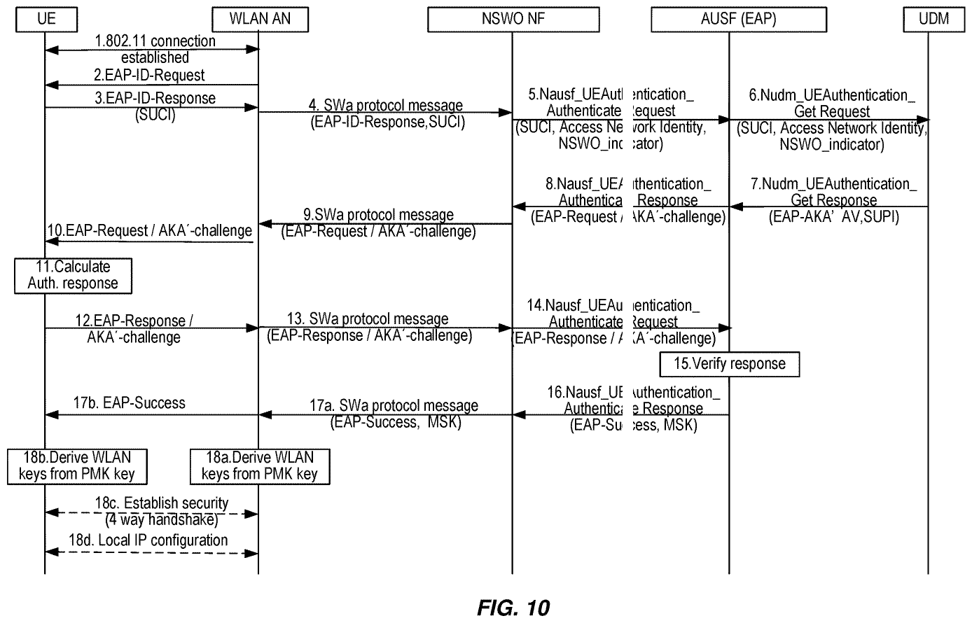

FIG. 10 shows a signaling diagram of an authentication procedure for non-seamless WLAN offload (NSWO) in 5GC. This procedure is further specified in 3GPP TS 33.501 (v17.5.0) section S.3 (Annex S).

According to current 3GPP specifications, a UE sets up a security context in 5GC during registration with 5GC. If the UE later decides to access a WLAN by performing NSWO access, the UE is unable to use the security context setup during 5GC registration. In other words, UE authentication needs to be performed twice: first during 5GC registration and again during NSWO access. These two UE authentications may occur near in time, which requires excessive signaling and processing in both UE and 5GC.

Embodiments of the present disclosure address these and other problems, issues, and/or difficulties by novel, flexible, and efficient techniques whereby a UE is allocated a temporary identifier during 5GC registration, and then reuses that temporary identifier for security procedures during later NSWO access. Based on this previously allocated identifier, the UE can perform abbreviated NSWO security procedures rather than a full AKA procedure as in conventional techniques. In different embodiments, the temporary identifier can be a 5G global unique temporary identifier (5G-GUTI) or a security key identifier (Kausf ID).

In other words, the established 5GS security context between UE and 5GC are reused as a security root (e.g., as pre-shared key) to authenticate the UE when performing an NSWO procedure. In such case, any extensible authentication protocol (EAP) method based on a pre-shared key can be used to authenticate the UE during NSWO access, instead of having to run a complete AKA procedure. By sending the temporary identifier (e.g., 5G-GUTI or Kausf ID) in the NSWO request, the UE indicates to the network that an existing 5GC security context can be used for NSWO authentication.

Embodiments can provide various benefits and/or advantages. For example, since only one authentication procedure is needed for a UE, this can reduce the signaling between UE and involved network entities (and among network entities), as well as processing load in UE and involved network entities, relative to conventional techniques that require two authentication procedures. Additionally, embodiments facilitate reduced delay when a UE registers to non-3GPP access network since the UE's security context is already available from earlier registration with 5GC.

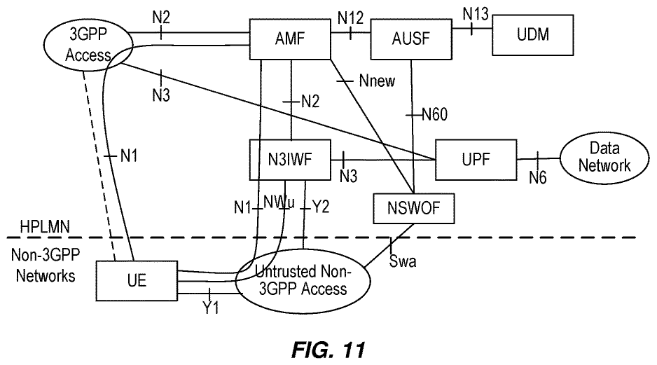

FIG. 11 shows an example non-roaming architectures for 5GC with untrusted non-3GPP access by UEs, according to some embodiments of the present disclosure. The architecture shown in FIG. 11 is similar to the architecture shown in FIG. 3, except for the addition of AUSF, UDM, and NSWOF and their respective interfaces. These include a new interface (called “Nnew”) between AMF and NSWOF. Note that NSWOF can be deployed in various ways not specifically illustrated in FIG. 11. For example, NSWOF could be co-located and/or integrated with AMF, trusted non-3GPP access point (TNAP), trusted WLAN AAA proxy (TWAP), etc.

Embodiments of the present disclosure can be roughly divided into first and second groups according to functionality. The first group of embodiments involve reusing security context established in a UE's serving PLMN for a later NSWO security procedure. Note that the serving PLMN may be different than the UE's HPLMN. The second group of embodiments involve reusing security context established in a UE's HPLMN for a later NSWO security procedure. Embodiments of these groups will be described in the context of the authentication procedure for NSWO in 5GS specified in 3GPP TS 33.501 (v17.5.0) Annex S.

Various embodiments of the first group are described below.

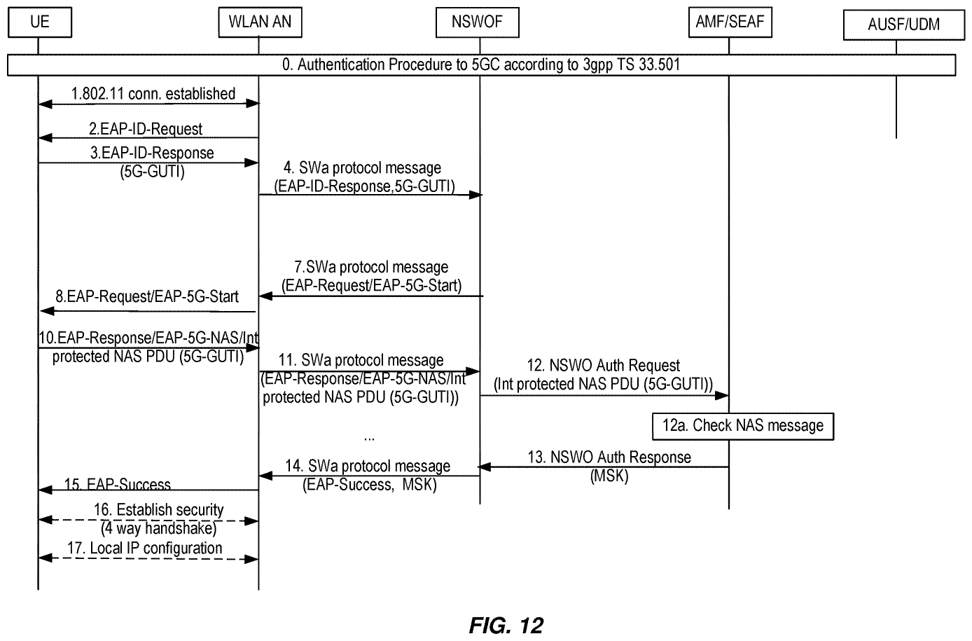

FIG. 12 shows a signaling diagram for an authentication procedure for NSWO in 5GS based on reusing security context, according to some embodiments of the present disclosure. Although the operations shown in FIG. 12 are given numerical labels, this is intended to facilitate explanation rather than to require or imply any sequential order, unless express stated or unambiguously implied by a particular context.

In operation 0, which can be considered a prerequisite and/or precondition, the UE authenticates and registers in 5GC and sets up a security context with the serving PLMN. This can include non-access stratum (NAS) security context, Kseaf/Kamf security keys, etc. The serving PLMN also allocates a 5G-GUTI to the UE.

In operation 1, the UE establishes a WLAN connection between the UE and the WLAN Access Network (AN), using procedures specified in IEEE 802.11. In operation 2, the WLAN AN sends an EAP Identity/Request to the UE. In operation 3, the UE responds with an EAP Response message and includes the 5G-GUTI in NAI format (i.e., username@realm format as specified in 3GPP TS 23.003 section 28.7.3) as its identity. If there are multiple NAS security contexts from different PLMNs, the UE may choose the NAS context and 5G-GUTI, considering the PLMN of the discovered NSWOF.

The UE may use the 5G-GUTI, instead of or in addiction to a SUCI) in an NAI format that the WLAN will route the EAP Response message to the NSWOF and not to, e.g., the TNGF (Trusted Network Gateway Function). The 5G-GUTI may take the form where the realm part of the NAI is for example: @5gc-nswo.mnc012.mc2645.3gppnetwork.org. An NAI with a “nai” in front of the realm, e.g., @nai.5gc-nn.mnc012.mc2645.3gppnetwork.org would be routed to the TNGF from the WLAN and a NAI with “5gc” in front of the realm, e.g. @5gc.xxx would be routed towards the NSWOF.

In operation 4, the EAP Response message is routed over the SWa interface towards the NSWOF based on the realm part of the 5G-GUTI. Operations 5-6 are intentionally omitted from FIG. 12.

In operation 7, the NSWOF determines that enhanced NSWO authentication is to be performed, based on the received 5G GUTI and possibly based on local policy. The NSWOF starts EAP-5G by sending the EAP-Request/EAP-5G-Start message to the WLAN AN via the SWa interface. In operation 8, the WLAN AN forwards EAP-Request/EAP-5G-Start message to the UE. Operation 9 is intentionally omitted from FIG. 12.

In operation 10, the UE sends the WLAN AN an EAP-Response/EAP-5G-NAS message that includes an integrity protected NAS message and the 5G-GUTI obtained in operation 0. The NAS message may be protected with an existing NAS security context associated with the 5G-GUTI. In operation 11, the WLAN AN forwards the EAP-Response/EAP-5G-NAS message to the NSWOF via the SWa interface. In operation 12, the NSWOF selects an AMF based on the received 5G-GUTI, and sends the integrity protected NAS message with the 5G GUTI to the selected AMF. This may be done using N2 message for transport, in some embodiments.

In operation 12a, upon receiving the NAS message, the AMF locates the correct UE context based on the 5G GUTI and checks the integrity of the NAS message. If the integrity check is successful, the procedure proceeds to operation 13. Otherwise, the AMF sends an error to NSWOF. In operation 13, the AMF derives a master session key (MSK) from Kamf and sends a NSWO authentication response message with the MSK to the NSWOF. This may be done using N2 message for transport, in some embodiments. The UE may derive MSK in accordance with 3GPP TS 33.501 (v17.6.0) Annex A.9

In operation 14, the NSWOF sends the EAP-success indication and MSK to WLAN AN over the SWa interface. In some embodiments, the NSWOF may derive another key from the key received from AMF and send the derived key to the WLAN. The WLAN AN forwards the EAP-Success indication to the UE in operation 15. In operations 16-17, the UE derives the MSK in a similar way as AMF in operation 13 and uses MSK to perform 4-way handshake to establish a secure connection with the WLAN AN.

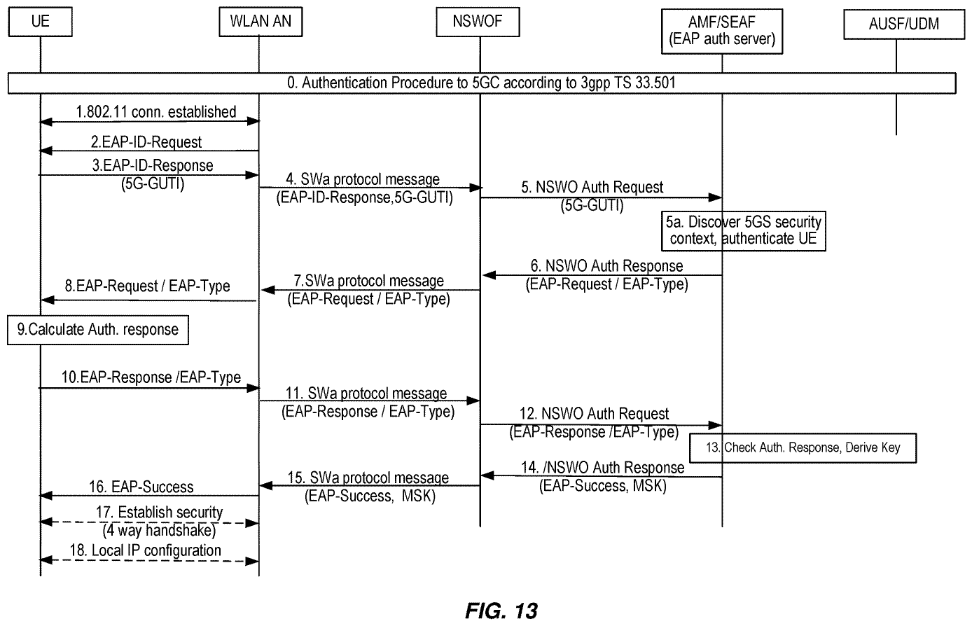

FIG. 13 shows a signaling diagram for an authentication procedure for NSWO in 5GS based on reusing security context, according to other embodiments of the present disclosure. In contrast to FIG. 12, the procedure in FIG. 13 involves performing an EAP method between UE and AMF. Although the operations shown in FIG. 13 are given numerical labels, this is intended to facilitate explanation rather than to require or imply any sequential order, unless express stated or unambiguously implied by a particular context.

Operations 0-4 in FIG. 13 are substantially identical to corresponding operations in FIG. 12. In operation 5, the NSWOF determines that enhanced NSWO authentication is to be performed, based on the received 5G GUTI and possibly based on local policy. The NSWOF selects an AMF based on the received 5G-GUTI and sends to the selected AMF an NSWO-Auth-Request message that includes the 5G-GUTI (an optionally an access network identity), using an N2 message for transport. For this operation, the NSWOF can use an existing N2 message or an N2 message defined specifically for this purpose.

In operation 5a, the AMF (or co-located security anchor function, SEAF) discovers the 5GS security context of the UE based on the 5G-GUTI and determines whether an enhanced NSWO authentication based on 5GS security context is allowed based on local policy. If allowed, the AMF/SEAF acts as EAP authentication server and uses the UE's 5GS security context (e.g., Kseaf, Kamf, NAS key, or a key derived from such a key) as a pre-shared symmetric credential to authenticate the UE. The AMF/SEAF may select a particular EAP method supporting symmetric credentials to use for the authentication, such as EAP PAP/CHAP, MS-CHAP v2, EAP-TTLS, etc. The selection may be based on local AMF/SEAF policy. In operation 6, the AMF sends to the NSWOF an EAP-Request message including an indication of the selected EAP method (EAP-Type), using an N2 message for transport.

In operation 7, the NSWOF sends the EAP-Request message with EAP-Type to the WLAN AN via the SWa interface. In operation 8, the WLAN AN forwards the EAP-Request message with EAP-Type to the UE. In operation 9, the UE calculates an authentication response based on its 5GS security context and the EAP method indicated by EAP-Type. In operation 10, the UE sends the WLAN AN an EAP-Response message that includes EAP-Type, which the WLAN AN forwards to NSWOF in operation 11 via the SWa interface. In operation 12, the NSWOF forwards the UE's EAP-Response message including EAP-Type to AMF/SEAF, using an N2 message for transport.

In operation 13, the AMF/SEAF verifies the UE's authentication based on the EAP-Response. If successful (as shown in FIG. 13), the AMF derives an MSK. The AMF may derive the key using the KDF in annex A.9 of TS 33.501 by using a new FC value or with a new Access Type Distinguisher as input, such as “NSWO access”. The AMF may also derive the key from Kseaf. In operation 14, the AMF/SEAF sends to the NSWOF an NSWO authentication response message with the MSK and an EAP-Success indication, using N2 message for transport.

In operation 15, the NSWOF sends the EAP-success and the key to WLAN AN over the SWa interface. The EAP-Success message is forwarded from WLAN AN to the UE. In some embodiments, the NSWOF may derive another key from the key received from AMF and send the derived key to the WLAN.

In operations 16, 17, and 18, the UE derives the same key (e.g., MSK) for the EAP method as the AMF did (and optionally as the NSWOF did) and uses the key to perform 4-way handshake to establish a secure connection with the WLAN AN.

In some embodiments of the method of FIG. 13, the AMF/SEAF starts EAP-5G protocol towards the UE. As a response, the UE then sends an integrity protected NAS message within the EAP-5G to the AMF/SEAF. The AMF/SEAF checks the integrity protected NAS message and if successful, generates a key (derived similarly as in operation 13 above). The AMF/SEAF then sends the EAP Success and the generated key to the NSWOF similarly as in operation 14 above. The rest of the procedure from operation 14 onwards may be as presented above. In such an embodiments, EAP-5G is performed between UE and AMF/SEAF instead of between UE and NSWOF.

Various embodiments of the second group—which involve reusing security context established in a UE's HPLMN—are described below.

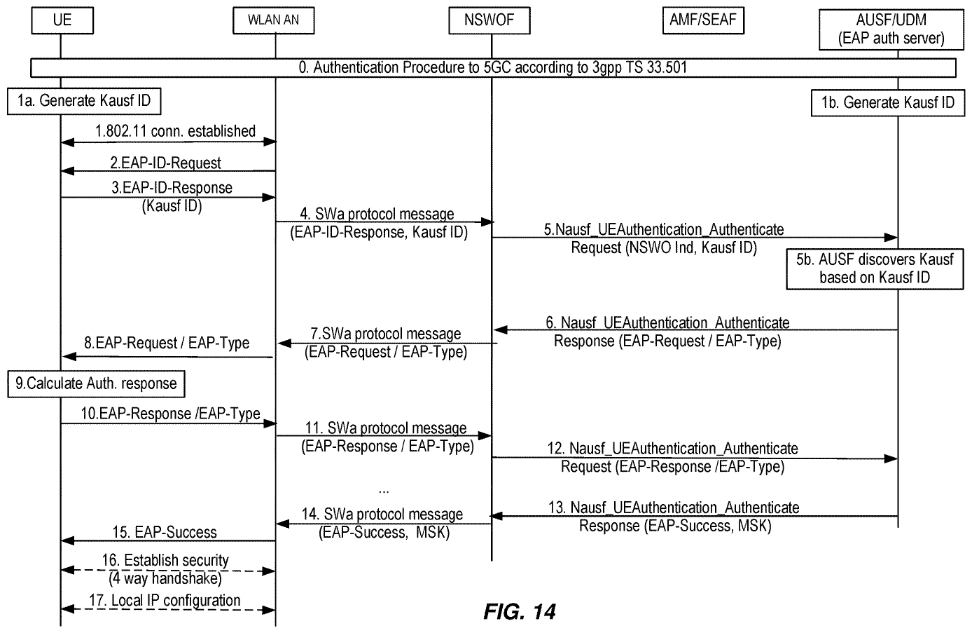

FIG. 14 shows a signaling diagram for an authentication procedure for NSWO in 5GS based on reusing security context, according to some embodiments of the present disclosure. In particular, the procedure shown in FIG. 14 involves using Kausf ID for NSWO authentication. Although the operations shown in FIG. 14 are given numerical labels, this is intended to facilitate explanation rather than to require or imply any sequential order, unless express stated or unambiguously implied by a particular context.

In operation 0, which can be considered a prerequisite or precondition, the UE registers in 5GC and sets up a security context with the serving PLMN. This includes non-access stratum (NAS) security context, Kseaf/Kamf security keys, etc. The serving PLMN also allocates a 5G-GUTI to the UE.

In operations 1a-b, the UE and AUSF/UDM each generate a security key Kausf as well as a temporary identity associated with Kausf, which is referred to as Kausf ID. For example, the Kausf ID can be in NAI format (as discussed above) and can be used to route to the UE's AUSF/UDM in the HPLMN, e.g., based on a PLMN ID and Routing Indicator included in the Kausf ID. The Kausf ID can be in NAI format where it could for example take the form: keyID@routingIndicator.homeplmn.com

In operation 1, the UE establishes a WLAN connection between the UE and the WLAN AN, using procedures specified in IEEE 802.11. In operation 2, the WLAN AN sends an EAP Identity/Request to the UE. In operation 3, the UE responds with an EAP Response/Identity message. The UE includes the Kausf ID in NAI format (i.e., username@realm format as specified in 3GPP TS 23.003 section 28.7.3) as its identity in the EAP Response/Identity message. In some embodiments, based on the local configuration, the UE attemts to reuse the 5GS security context in the HPLMN for NSWO authentication and uses the Kausf ID in NAI format (i.e., username@realm format). The UE uses the Kausf ID in such NAI format that the WLAN will route the message (EAP Response/Identity message) to the NSWOF and not to, e.g., TNGF (Trusted Network Gateway Function).

In operation 4, the EAP Response/Identity message is routed over the SWa interface to the NSWOF based on the realm part of the Kausf ID.

In operation 5, the NSWOF determines that enhanced NSWO authentication is to be performed, based on the received Kausf ID and possibly based on local policy. The NSWOF selects an AUSF based on the received 5G-GUTI and sends to the selected AUSF an Nausf UEAuthentication_Authenticate Request message that includes the Kausf ID and an NWSO indicator.

In operation 5b, based on the received Kausf ID, the AUSF discovers whether it has a locally stored Kausf (e.g., generated in operation 1b). If so, the AUSF resolves the UE's subscription concealed identifier (SUCI) based on Kausf ID. If not, the AUSF discovers whether there is another AUSF that stores Kausf for this UE and, if so, forwards Kausf ID to that other AUSF for similar processing.

After resolving the UE's SUCI, the AUSF determines whether an enhanced NSWO authentication based on 5GS security context is allowed based on local policy. If allowed, based on the received KausfID, the AUSF discovers if a 5GS security context (e.g., Kausf) to authenticate the UE exists. The AUSF may select a particular EAP method supporting symmetric credentials to use for the authentication, such as, EAP PAP/CHAP, MS-CHAP v2, EAP-TTLS, etc. The selection may be based on local AUSF policy.

As an alternative to operation 5b, the AUSF can treat the received Kausf ID as a fast re-authentication ID for EAP-AKA′ and triggers EAP-AKA′ fast re-authentication.

In operation 6, the AUSF sends to the NSWOF an EAP-Request message including an indication of the selected EAP method (EAP-Type), using an Nausf_UEAuthentication Authenticate Response message for transport. Operations 7-11 in FIG. 14 are substantially identical to corresponding operations in FIG. 13.

In operation 12, the NSWOF forwards the UE's EAP-Response message including EAP-Type to AUSF/UDM, using an Nausf_UEAuthentication_Authenticate Request message for transport. In operation 13, the AUSF verifies the UE's authentication based on the EAP-Response. If successful (as shown in FIG. 14), the AUSF derives an MSK and sends the MSK and an EAP-Success indication to the NSWOF, using an Nausf_UEAuthentication Authenticate Response message for transport. Operations 14-17 in FIG. 14 are substantially identical to corresponding operations in FIGS. 12-13.

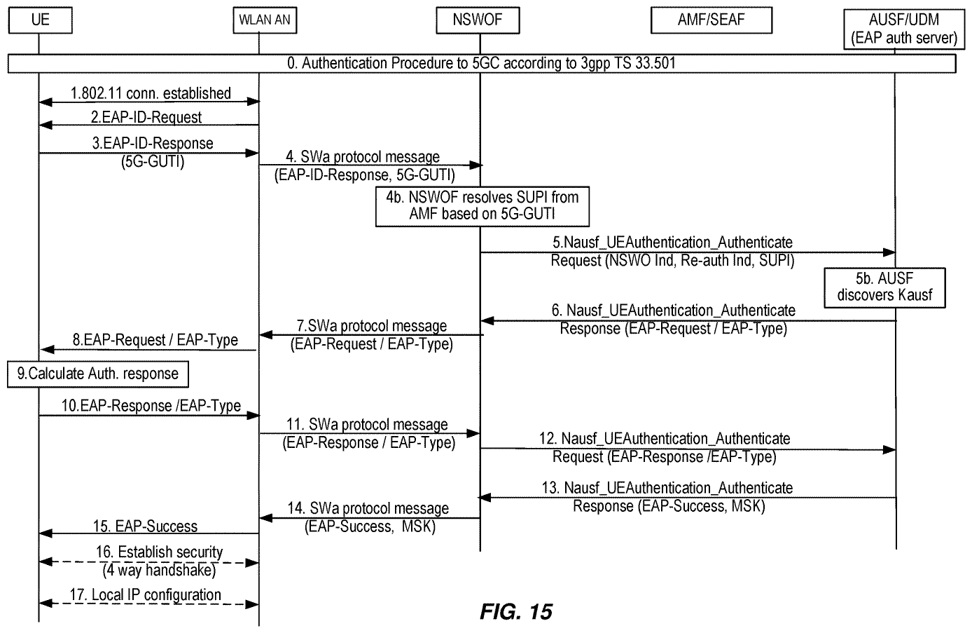

FIG. 15 shows a signaling diagram for an authentication procedure for NSWO in 5GS based on reusing security context, according to other embodiments of the present disclosure. In particular, the procedure shown in FIG. 15 involves using 5G-GUTI for NSWO authentication. Although the operations shown in FIG. 15 are given numerical labels, this is intended to facilitate explanation rather than to require or imply any sequential order, unless express stated or unambiguously implied by a particular context.

Operations 0-4 in FIG. 15 are substantially identical to corresponding operations in FIGS. 12-13. However, instead of generating Kauf ID, the UE uses the 5G-GUTI as UE ID for NSWO procedure, optionally with an additional re-authentication indicator to indicate reusing security context in HPLMN is wanted. In operation 4b, the NSWOF decides to trigger an NSWO authentication procedure towards AUSF (e.g., based on the message in operation 4 and local policy) and resolves the UE's subscription permanent identifier (SUPI) based a newly defined AMF service operation (not shown in FIG. 15). The NSWOF sends the 5G-GUTI to AMF and receives the corresponding SUPI in response.

In operation 5, the NSWOF determines that enhanced NSWO authentication is to be performed and sends to the AUSF an Nausf_UEAuthentication_Authenticate Request message that includes the SUPI, an NWSO indicator, and a reauthentication indicator. In operation 5b, based on the received SUPI, the AUSF discovers whether it has a locally stored Kausf (e.g., generated in operation 1b). If not, the AUSF discovers whether there is another AUSF that stores Kausf for this UE and, if so, forwards SUPI to that other AUSF for similar processing.

Otherwise, the AUSF determines whether an enhanced NSWO authentication based on 5GS security context is allowed based on local policy. If allowed, the AUSF uses Kausf as a pre-shared symmetric credential to authenticate the UE. The AUSF may select a particular EAP method supporting symmetric credentials to use for the authentication, such as EAP PAP/CHAP, MS-CHAP v2, EAP-TTLS, etc. The selection may be based on local AUSF policy.

Operations 6-17 in FIG. 15 are substantially identical to corresponding operations in FIG. 14.

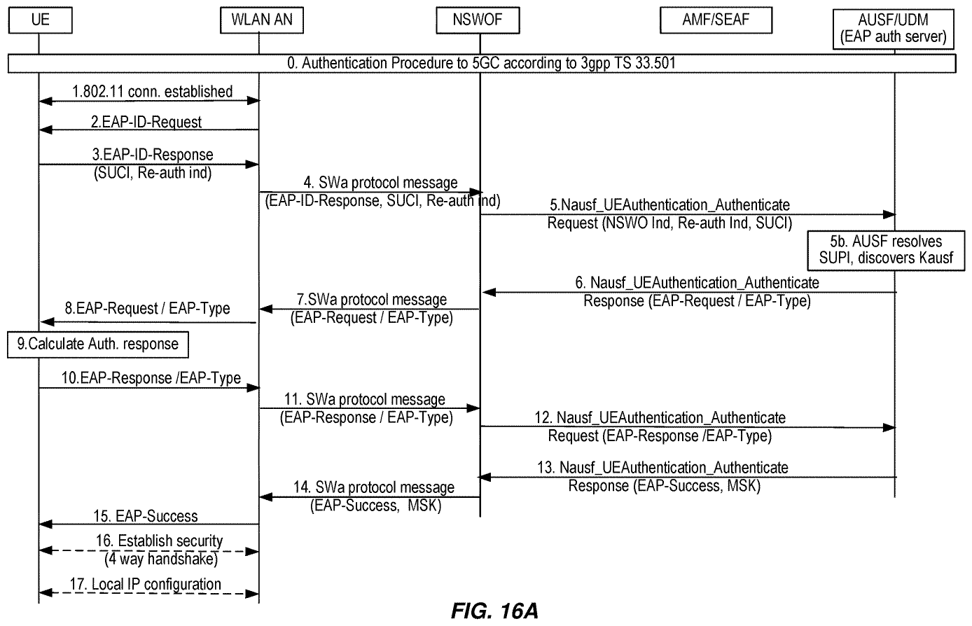

FIG. 16 shows a signaling diagram for an authentication procedure for NSWO in 5GS based on reusing security context, according to other embodiments of the present disclosure. In particular, the procedure shown in FIG. 16 involves using SUCI and a reauthentication indicator for NSWO authentication. Although the operations shown in FIG. 16 are given numerical labels, this is intended to facilitate explanation rather than to require or imply any sequential order, unless express stated or unambiguously implied by a particular context.

Operations 0-2 in FIG. 16A are substantially identical to corresponding operations in FIGS. 12-15. In operation 3, the UE responds with an EAP Response message that includes the UE's SUCI in NAI format (i.e., username@realm format as specified in 3GPP TS 23.003 section 28.7.3) and a reauthentication indicator to indicate reusing security context in HPLMN is wanted. In operation 4, the EAP Response message is routed over the SWa interface towards the NSWOF based on the realm part of the SUCI.

In operation 5, based on the received information, the NSWOF determines that enhanced NSWO authentication is to be performed and sends to the AUSF an Nausf UEAuthentication Authenticate Request message that includes the SUCI, the reauthentication indicator, and an NWSO indicator. In operation 5b, the AUSF resolves the UE's SUPI based on the received SUCI, and discovers whether it has a locally stored Kausf corresponding to the SUPI (e.g., generated in operation 1b). If not, the AUSF discovers whether there is another AUSF that stores Kausf for this UE and, if so, forwards SUPI to that other AUSF for similar processing. Alternatively, the NSWOF may first select a UDM in the HPLMN based on the SUCI and request the UDM to provide the AUSF ID storing the Kausf for the UE/SUPI (after reconcealing SUPI from received SUCI). The NSWOF may then trigger NSWO authentication towards the AUSF with SUPI and Re-authentication indicator. The AUSF then runs the authentication procedure similarly as the earlier embodiment.

Otherwise, the AUSF determines whether an enhanced NSWO authentication based on 5GS security context is allowed based on local policy. If allowed, the AUSF uses Kausf as a pre-shared symmetric credential to authenticate the UE. The AUSF may select a particular EAP method supporting symmetric credentials to use for the authentication, such as EAP PAP/CHAP, MS-CHAP v2, EAP-TTLS, etc. The selection may be based on local AUSF policy.

Operations 6-17 in FIG. 16A are substantially identical to corresponding operations in FIGS. 14-15.

FIG. 16B is similar in many respects to FIG. 16B. The method is similar, with the following exceptions. In operations 1-4, the UE uses SUCI as UE ID for NSWO procedure with an additional re-authentication indicator to indicate reusing security context in HPLMN is wanted. Additionally, the UE integrity protects the information within the EAP-ID-Response using Kausf derived during primary authentication with the 5GC, or with a key derived from the Kausf.

In operations 5 and 5b, based on the received re-authentication indicator the NSWOF triggers NSWO authentication towards the AUSF with the integrity protected SUCI and re-authentication indicator payload. The AUSF resolves the SUCI to SUPI from UDM and discovers if there is an existing Kausf stored locally or in another AUSF via UDM and forwards the request to that AUSF.

In some embodiments, the NSWOF may first select a UDM in the HPLMN based on the SUCI and request the UDM to provide the AUSF ID storing the Kausf for the UE/SUPI, after reconcealing SUPI from received SUCI. The NSWOF then triggers NSWO authentication towards the AUSF with SUPI and the integrity protected SUCI and re-authentication indicator payload.

The AUSF then determines whether an enhanced NSWO authentication based on 5GS security context in the home network is allowed, in some embodiments, based on the local policy. If allowed, the AUSF checks the integrity of the Authentication Request message using the Kausf or a key derived from the Kausf. If the integrity check is successful, the method continues. Otherwise, the AUSF may send an error to the NSWOF.

The AUSF derives a key (e.g., an MSK) from Kausf (or from a key derived from Kausf) and continues the procedure as in step 13-17 in FIG. 16A.

FIG. 16C is similar in some respects to FIGS. 16A and 16B. However, in FIG. 16C, the network entity that stores the established 5GS security context for the UE, e.g. AMF/SEAF with NAS security context or AUSF with Kausf, acts as the backend storage of the security root, e.g., pre-shared key based on the established 5GS security context for the UE. And NSWOF acts as EAP server and fetch the security credential from these backends to proceed to EAP procedure. As shown in FIG. 16C, the EAP method is performed between UE and NSWOF.

In operations 1-3, the procedures are similar to those described above. If the UE intends to reuse the NAS security context for NSWO authentication, the UE uses the existing 5G-GUTI in NAI format (i.e., username@realm format) as UE ID. If the UE intends to reuse 5GS security context in the HPLMN for NSWO authentication for NSWO authentication, the UE uses Kausf ID or 5G-GUTI or SUCI, as described in embodiments above, and in some embodiments, with an additional re-authentication indicator to indicate reusing security context in HPLMN is wanted.

In operation 4, the WLAN will route the EAP Response/Identity message over the SWa interface towards the NSWOF based on the realm part of the received UE ID. In operations 5 (one of 5a and 5b) and 6 (the corresponding one of 6a and 6b), based on the received UE ID, the NSWOF determines that enhanced NSWO authentication is to be performed and the backend storage to fetch the authentication credential. In some embodiments, the NSWOF considers local policy in making the determination.

In operation 5a, the 5G-GUTI is received and NAS security context is to be used for NSWO authentication. The NSWOF selects an AMF based on the 5G-GUTI and sends a message to the AMF including an NSWO Auth Credential Request message, containing 5G-GUTI. In operation 6a, the AMF/SEAF discovers the security context of the UE based on the 5G-GUTI and, in some embodiments, determines whether an enhanced NSWO authentication based on 5GS security context is allowed. The determination may be made based on local policy. If allowed, the AMF/SEAF uses the key in the existing 5GS security context (e.g., Kseaf, Kamf, or NAS key) or a key derived from such a key as pre-shared symmetric authentication credential and send back the authentication credential to NSWOF.

In operation 5b, if Kausf ID or 5G-GUTI or SUCI (optionally with an additional re-authentication indicator) is received and security context in HPLMN is to be used for NSWO authentication, the NSWOF selects an AUSF based on the Kausf ID or SUCI or resolves the received 5G-GUTI to SUPI from AMF and selects an AUSF based on the SUPI. In operation 6b, the AUSF discovers if there is existing Kausf stored locally and resolves UE's SUPI based on Kausf ID/SUCI. In some embodiments, the AUSF may determine whether an enhanced NSWO authentication based on 5GS security context/Kausf is allowed based on the local policy. If allowed, the AUSF uses Kausf or a Key derived from Kausf as pre-shared symmetric authentication credential and send back the authentication credential to NSWOF. Based on the received authentication credential, the NSWOF decides the EAP method to be used that supports the symmetric credential, e.g., EAP PAP/CHAP, MS-CHAP v2, EAP-TTLS etc. In some embodiments, this decision may be based on local policy.

The operations 7-11 may be similar as decibed in connection with FIGS. 16A and 16B. In operation 12, the NSWOF checks the authentication response. If authentication is successful, the NSWOF generates a key (e.g., MSK) from on the received authentication credential. In operation 13, the NSWOF sends the EAP-success and the key to WLAN AN over the SWa interface. The EAP-Success message is forwarded from WLAN AN to the UE. In some embodiments, the NSWOF may derive another key from the key received from AMF and send the derived key to the WLAN.

Operations 14 and 15 may be similar to the corresponding methods described herein. The UE derives the same key (e.g., MSK) for the EAP method as the NSWOF did and uses the key to perform 4-way handshake to establish a secure connection with the WLAN AN.

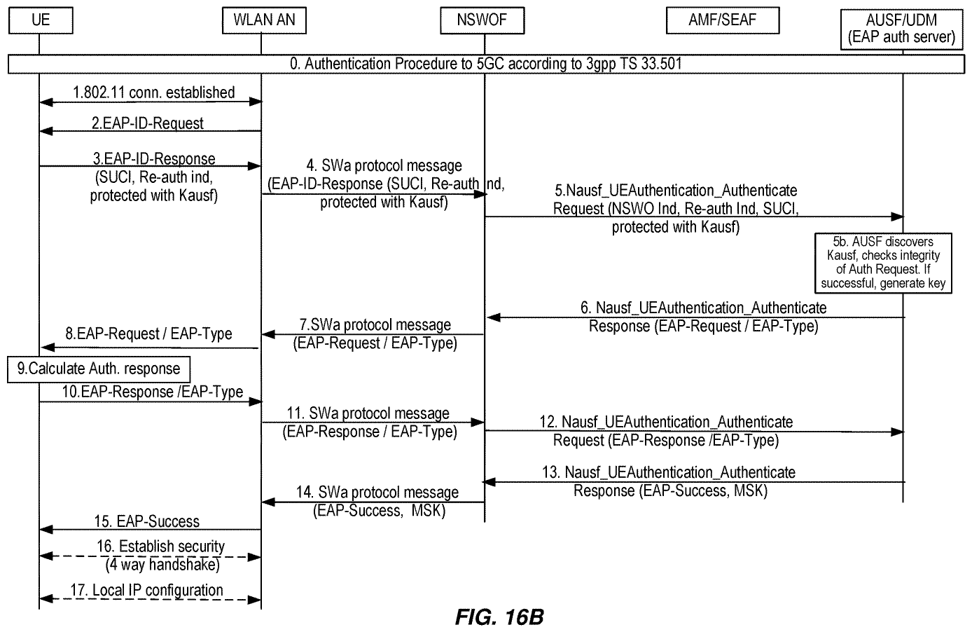

The embodiments described above are further illustrated by FIGS. 17-20, which depict example methods (e.g., procedures) for a UE, an NSWOF, an AMF, and an AUSF, respectively. Put differently, various features of the operations described below correspond to various embodiments described above, including the embodiments shown in FIGS. 12-16. The example methods shown in FIGS. 17-20 can be used cooperatively (e.g., with each other and with other procedures described herein) to provide benefits, advantages, and/or solutions to problems described herein. Although the example methods are illustrated in FIGS. 17-20 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 17 illustrates an example method (e.g., procedure) for a UE configured to communicate with a communication network (e.g., 5GC) via a WLAN, according to various embodiments of the present disclosure. For example, the example method shown in FIG. 17 can be performed by a UE (e.g., wireless device) such as described elsewhere herein.

The example method can include the operations of block 1710, where the UE perform an authentication with the communication network, including obtaining an identifier associated with user credentials on which the authentication is based. The example method can also include the operations of block 1720, where the UE can subsequently send, to the WLAN, a request for authorization to connect to the WLAN, wherein the request for authorization includes the identifier. The example method can also include the operations of block 1760, where the UE can receive, from the communication network via the WLAN, an authorization to connect to the WLAN. The authorization is based on the identifier. The example method can also include the operations of block 1770, where the UE can establish a secure connection with the WLAN based on the received authorization.

In some embodiments, performing an authentication with the communication network in block 1710 includes the operations of sub-block 1711, where the UE can derive one or more security keys based on the user credentials. In some of these embodiments, establishing a secure connection with the WLAN in block 1770 can include the operations of sub-blocks 1771-1772, where the UE can derive a master session key (MSK) based on one of the derived security keys and use the derived MSK to establish the secure connection with the WLAN.

In some of these embodiments, the identifier associated with user credentials is one of the following: a temporary UE identifier assigned by the communication network (e.g., 5G-GUTI), a security key identifier derived by the UE (e.g., Kausf ID), or a concealed identifier of a user subscription to the communication network (e.g., SUCI).

In some variants, the request for authorization (e.g., in block 1720) includes the concealed identifier of a user subscription to the communication network and a UE reauthorization indicator. FIG. 16 shows an example of these variants.

In other variants, obtaining the identifier associated with user credentials in block 1710 includes the operations of sub-block 1711, where the UE can derive the security key identifier (i.e., included in the request for authorization) from one of the derived security keys. FIG. 14 shows an example of these variants.

In other variants, the example method can also include the operations of blocks 1730 and 1750, where in response to the request for authorization (e.g., in block 1710), the UE can receive an authentication request from the communication network via the WLAN and send an authentication response to the communication network via the WLAN. In such case, the authorization to connect is received in response to the authentication response.

In some further variants, the authentication response includes the temporary UE identifier, such as contained in a protocol data unit that is integrity-protected based on the user credentials. FIG. 12 shows an example of these variants.

In other further variants, the authentication request includes an identifier of an authentication method or algorithm and the example method also includes the operations of block 1740, where the UE can calculate the authentication response based on one of the derived security keys and on the identified authentication method or algorithm. FIGS. 13-16 show examples of these variants.

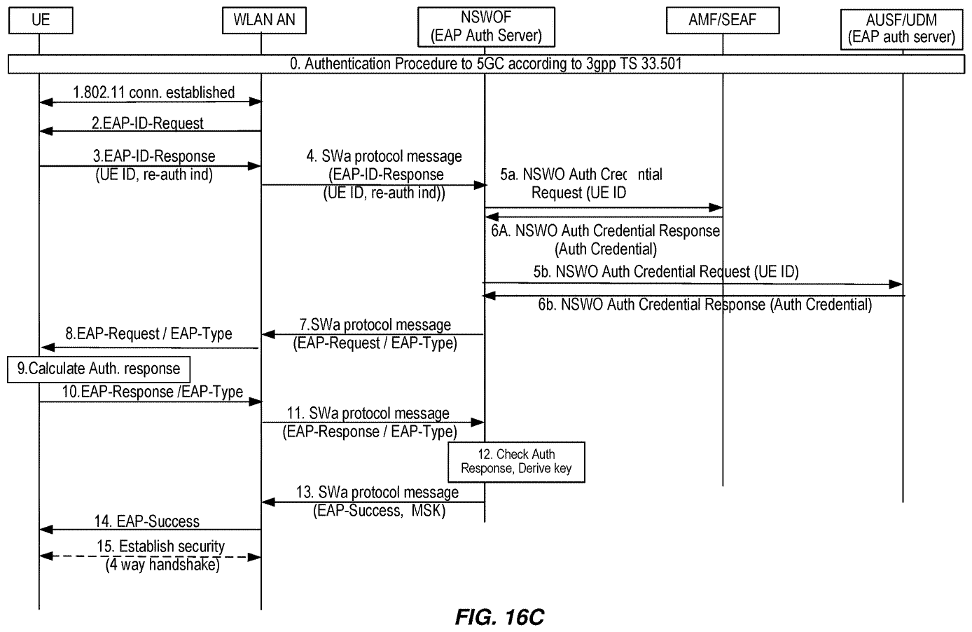

In addition, FIG. 18 illustrates an example method (e.g., procedure) for an NSWOF associated with a communication network (e.g., 5GC), according to various embodiments of the present disclosure. For example, the example method shown in FIG. 18 can be performed by an NSWOF (or a network node hosting the same) such as described elsewhere herein.

The example method can include the operations of blocks 1810, where the NSWOF can receive, from a UE via a WLAN, a request for authorization for the UE to connect to the WLAN, wherein the request for authorization includes an identifier associated with user credentials for the communication network. The example method can include the operations of blocks 1840, where the NSWOF can send, to a network node or function (NNF) of the communication network, a request for UE authentication that includes the identifier or a representation thereof. The example method can include the operations of blocks 1870, where the NSWOF can receive, from the NNF, an authorization for the UE to connect to the WLAN, wherein the authorization is based on the identifier. The example method can include the operations of blocks 1880, where the NSWOF can forward the authorization to the WLAN and to the UE via the WLAN.

In some embodiments, the authorization for the UE to connect to the WLAN is received together with a master session key (MSK) for securing a connection between the UE and the WLAN, and the MSK is sent to the WLAN together with the authorization for the UE to connect.

In some embodiments, one of the following identifiers is received in the request for authorization and sent in the request for UE authentication: a temporary UE identifier assigned by the communication network (e.g., 5G-GUTI), a security key identifier derived by the UE (e.g., Kausf ID), or a concealed identifier of a user subscription to the communication network (e.g., SUCI). FIGS. 12-14 and 16 show examples of these embodiments.

In other embodiments, the identifier received in the request for authorization is a temporary UE identifier and the example method also includes the operations of block 1830, where based on the received temporary UE identifier, the NSWOF can derive or determine a permanent identifier of a user subscription to the communication network (e.g. SUPI), with the permanent identifier being sent in the request for UE authentication. FIG. 15 shows an example of these embodiments.

In some embodiments, the example method can also include the NSWOF performing the following operations, labelled with corresponding block numbers:
(1850) in response to the request, receiving from the NNF a first response that includes an authentication request for the UE and an identifier of an authentication method or algorithm;
(1855) forwarding the authentication request and the identifier of an authentication method or algorithm to the UE via the WLAN;
(1860) receiving an authentication response from the UE via WLAN; and
(1865) forwarding the authentication response to the NNF.

The authorization for the UE to connect to the WLAN is received (e.g., in block 1870) in response to the authentication response (e.g., in block 1865). FIGS. 13-16 show examples of these embodiments.

In other embodiments, the example method can also include the NSWOF performing the following operations, labelled with corresponding block numbers:
(1820) in response to the request for authorization including the temporary UE identifier, sending an authentication request to the UE via the WLAN; and
(1825) receiving, from the UE via the WLAN, an authentication response that includes the temporary UE identifier.

The authentication response from the UE is sent to the NNF in the request for UE authorization (e.g., in block 1840). In some of these embodiments, the temporary UE identifier in the authentication response is contained in a protocol data unit that is integrity-protected based on the user credentials. FIG. 12 shows an example of these embodiments.

In some embodiments, the NNF is an access and mobility management function (AMF). In other embodiments, the NNF is an authentication support function (AUSF) and the request for UE authentication also includes one or more of the following: a non-seamless WLAN offload (NSWO) indicator, and a UE reauthentication indicator.

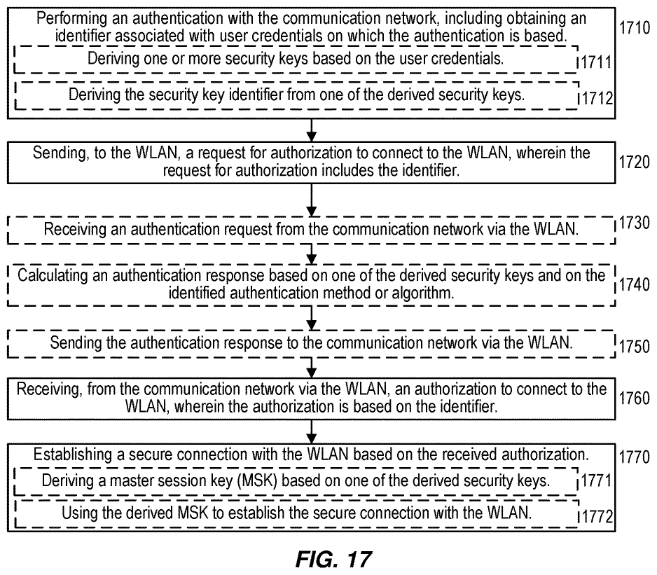

In addition, FIG. 19 illustrates an example method (e.g., procedure) for an AMF associated with a communication network (e.g., 5GC), according to various embodiments of the present disclosure. For example, the example method shown in FIG. 19 can be performed by an AMF (or a network node hosting the same or similar functionality) such as described elsewhere herein.

The example method can include the operations of block 1910, where the AMF can receive, from an NSWOF associated with the communication network, a request for authorization of a UE for access to a WLAN. The request includes an identifier associated with user credentials for the communication network. The example method can include the operations of block 1920, where based on the identifier, the AMF can discover a valid UE security context stored in the communication network. The example method can also include the operations of block 1990, where based on the discovered UE security context, the AMF can send to the NSWOF an authorization for the UE to connect to the WLAN.

In some embodiments, the identifier is a temporary UE identifier assigned by the communication network (e.g., 5G-GUTI). In some of these embodiments, the temporary UE identifier is contained in a protocol data unit (PDU) that is integrity-protected based on the user credentials and the example method can also include the operations of block 1925, where the AMF can verify the integrity of the PDU based on the UE security context. FIG. 12 shows an example of these embodiments.

In other embodiments, the example method can include the AMF performing the following operations, labelled with corresponding block numbers:
(1930) selecting an authentication method or algorithm to be used for authenticating the UE;
(1940) calculating a UE authentication response based on the UE security context and on the selected authentication method or algorithm;
(1950) sending to the NSWOF a response that includes an authentication request for the UE and an identifier of the authentication method or algorithm;
(1960) receiving an authentication response from the UE via the NSWOF; and
(1970) determining whether the authentication response from the UE matches the calculated UE authentication response.

The authorization for the UE to connect to the WLAN is sent (e.g., in block 1990) based on determining a match (e.g., in block 1970). FIG. 13 shows an example of these embodiments.

In some of these embodiments, the example method can also include the operations of block 1980, where based on determining a match, the AMF can derive a MSK for securing a connection between the UE and the WLAN, based on one or more security keys in the UE security context. The MSK is sent to the NSWOF in block 1990 together with the authorization for the UE to connect to the WLAN.

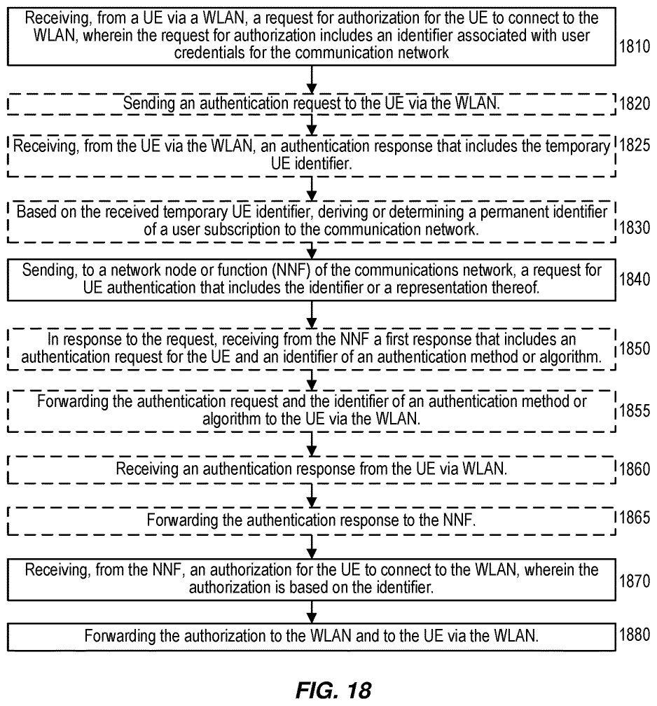

In addition, FIG. 20 illustrates an example method (e.g., procedure) for an AUSF associated with a communication network (e.g., 5GC), according to various embodiments of the present disclosure. For example, the example method shown in FIG. 20 can be performed by an AUSF (or a network node hosting the same or similar functionality) such as described elsewhere herein.

The example method can include the operations of block 2010, where the AUSF can receive, from an NSWOF associated with the communication network, a request for authorization of a UE for access to a WLAN. The request includes an identifier associated with user credentials for the communication network. The example method can include the operations of block 2020, where based on the identifier, the AUSF can discover a valid UE security key stored in the communication network. The example method can also include the operations of block 2090, where based on the discovered UE security key, the AUSF can send to the NSWOF an authorization for the UE to connect to the WLAN.

In some embodiments, the identifier included in the request is a temporary UE identifier assigned by the communication network (e.g., 5G-GUTI) and discovering a valid UE security key in block 2020 includes the operations of sub-block 2021, where the AUSF can detect a match between the received security key identifier and a corresponding identifier of the valid UE security key stored in the communication network.

In other embodiments, the identifier included in the request is one of the following: a permanent identifier of a user subscription to the communication network, or a concealed identifier of a user subscription to the communication network. In some of these embodiments, discovering a valid UE security key in block 2020 includes the operations of sub-block 2023, where the AUSF can identify the valid UE security key in a stored UE security context associated with the permanent identifier of the user subscription to the communication network. In some variants, discovering a valid UE security key in block 2020 includes the operations of sub-block 2022, where the AUSF can determine the permanent identifier based on the concealed identifier included in the request. FIG. 16 shows an example of these variants.

In some embodiments, the example method can include the AUSF performing the following operations, labelled with corresponding block numbers:
(2030) selecting an authentication method or algorithm to be used for authenticating the UE;
(2040) calculating a UE authentication response based on the UE security key and on the selected authentication method or algorithm;
(2050) sending to the NSWOF a response that includes an authentication request for the UE and an identifier of the authentication method or algorithm;
(2060) receiving an authentication response from the UE via the NSWOF; and
(2070) determining whether the authentication response from the UE matches the calculated UE authentication response.

The authorization for the UE to connect to the WLAN is sent (e.g., in block 2090) based on determining a match (e.g., in block 2070). FIGS. 14-16 show examples of these embodiments.

In some of these embodiments, the example method can also include the operations of block 2080, where based on determining a match, the AUSF can derive a MSK for securing a connection between the UE and the WLAN, based on one or more security keys in the UE security key. The MSK is sent to the NSWOF in block 2090 together with the authorization for the UE to connect to the WLAN.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

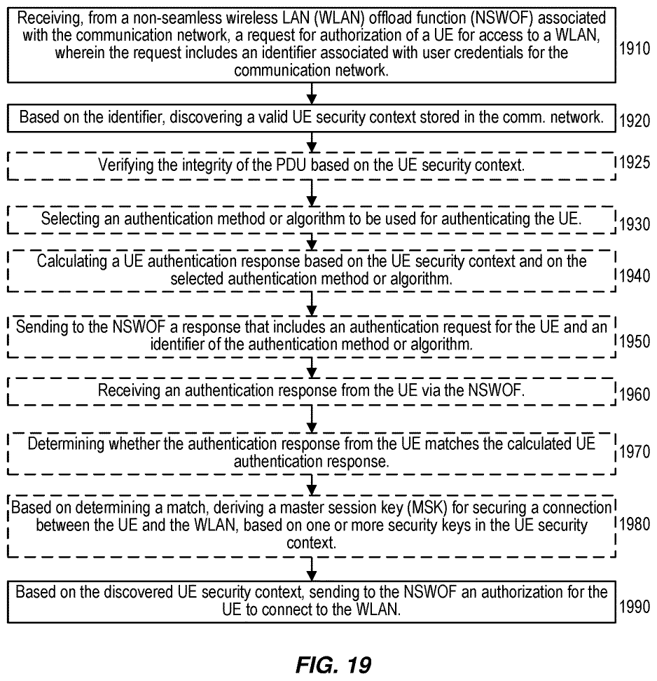

FIG. 21 shows an example of a communication system 2100 in accordance with some embodiments. In this example, the communication system 2100 includes a telecommunication network 2102 that includes an access network 2104, such as a radio access network (RAN), and a core network 2106, which includes one or more core network nodes 2108. The access network 2104 includes one or more access network nodes, such as network nodes 2110a and 2110b (one or more of which may be generally referred to as network nodes 2110), or any other similar 3GPP access node or non-3GPP access point. The network nodes 2110 facilitate direct or indirect connection of UEs, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), non-seamless WLAN offload function (NSWOF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 21 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 2104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

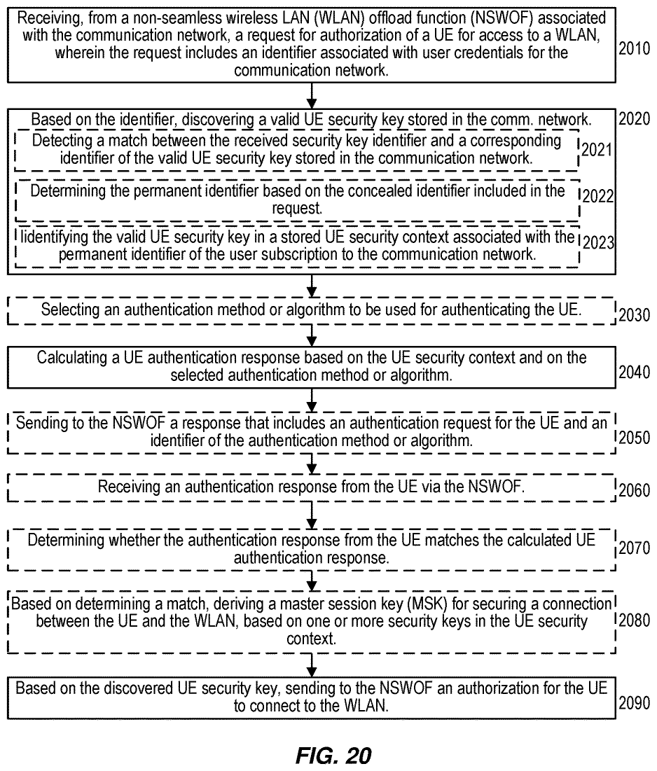

FIG. 22 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (30D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 22. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 22.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

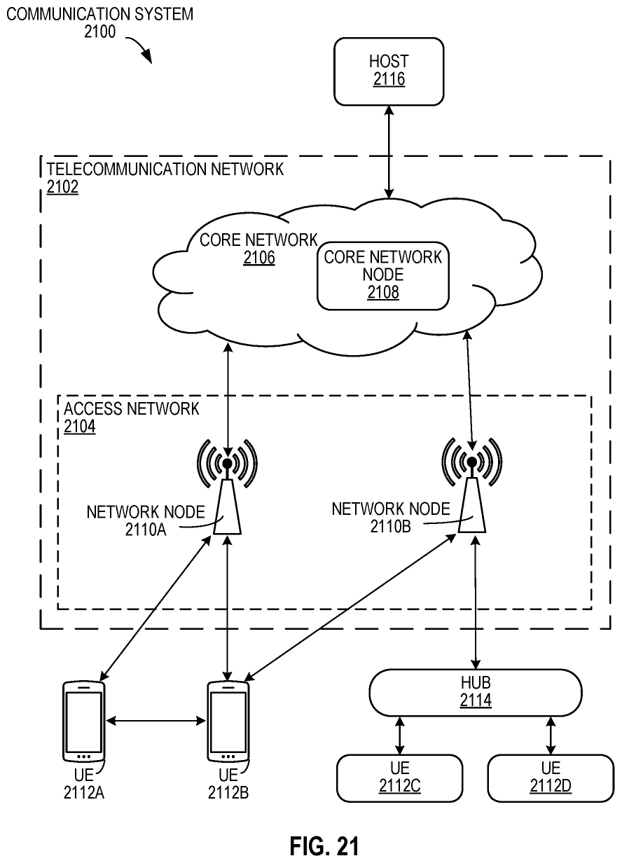

FIG. 23 shows a network node 2300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Business Support System (BSS) nodes Self-Organizing Network (SON) nodes, core network nodes (e.g., that host or implement network functions), positioning nodes (e.g., Evolved Serving Mobile Location Centers, E-SMLCs), and/or Minimization of Drive Test (MDT) nodes.

As more specific examples, various embodiments of network node 2300 can be arranged to perform various operations of example methods (e.g., procedures) attributed to NSWOFs, AMFs, and AUSFs in the above description, including embodiments described in relation to FIGS. 18-20.

The network node 2300 includes a processing circuitry 2302, a memory 2304, a communication interface 2306, and a power source 2308. The network node 2300 may be composed of multiple physically separate components (e.g., a NodeB component and a RNC component, or a BTS component and a BSC component, etc.), which may each have their own respective components. In certain scenarios in which the network node 2300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2300 may be configured to support multiple radio access technologies (RATs). In such embodiments, some components may be duplicated (e.g., separate memory 2304 for different RATs) and some components may be reused (e.g., a same antenna 2310 may be shared by different RATs). The network node 2300 may also include multiple sets of the various illustrated components for different wireless technologies integrated into network node 2300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2300.

The processing circuitry 2302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2300 components, such as the memory 2304, to provide network node 2300 functionality.

In some embodiments, the processing circuitry 2302 includes a system on a chip (SOC). In some embodiments, the processing circuitry 2302 includes one or more of radio frequency (RF) transceiver circuitry 2312 and baseband processing circuitry 2314. In some embodiments, the radio frequency (RF) transceiver circuitry 2312 and the baseband processing circuitry 2314 may be on separate chips (or sets of chips), boards, or units, such as radio units and digital units. In alternative embodiments, part or all of RF transceiver circuitry 2312 and baseband processing circuitry 2314 may be on the same chip or set of chips, boards, or units.

The memory 2304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2302. The memory 2304 may store any suitable instructions, data, or information, including a computer program, software, an application including one or more of logic, rules, code, tables, and/or other instructions (collectively denoted computer program product 2304a) capable of being executed by the processing circuitry 2302 and utilized by the network node 2300. The memory 2304 may be used to store any calculations made by the processing circuitry 2302 and/or any data received via the communication interface 2306. In some embodiments, the processing circuitry 2302 and memory 2304 is integrated.

The communication interface 2306 is used in wired or wireless communication of signaling and/or data between a network node, access network, and/or UE. As illustrated, the communication interface 2306 comprises port(s)/terminal(s) 2316 to send and receive data, for example to and from a network over a wired connection. The communication interface 2306 also includes radio front-end circuitry 2318 that may be coupled to, or in certain embodiments a part of, the antenna 2310. Radio front-end circuitry 2318 comprises filters 2320 and amplifiers 2322. The radio front-end circuitry 2318 may be connected to an antenna 2310 and processing circuitry 2302. The radio front-end circuitry may be configured to condition signals communicated between antenna 2310 and processing circuitry 2302. The radio front-end circuitry 2318 may receive digital data that is to be sent out to other network nodes or UEs via a wireless connection. The radio front-end circuitry 2318 may convert the digital data into a radio signal having the appropriate channel and bandwidth parameters using a combination of filters 2320 and/or amplifiers 2322. The radio signal may then be transmitted via the antenna 2310. Similarly, when receiving data, the antenna 2310 may collect radio signals which are then converted into digital data by the radio front-end circuitry 2318. The digital data may be passed to the processing circuitry 2302. In other embodiments, the communication interface may comprise different components and/or different combinations of components.

In certain alternative embodiments, the network node 2300 does not include separate radio front-end circuitry 2318, instead, the processing circuitry 2302 includes radio front-end circuitry and is connected to the antenna 2310. Similarly, in some embodiments, all or some of the RF transceiver circuitry 2312 is part of the communication interface 2306. In still other embodiments, the communication interface 2306 includes one or more ports or terminals 2316, the radio front-end circuitry 2318, and the RF transceiver circuitry 2312, as part of a radio unit (not shown), and the communication interface 2306 communicates with the baseband processing circuitry 2314, which is part of a digital unit (not shown).

The antenna 2310 may include one or more antennas, or antenna arrays, configured to send and/or receive wireless signals. The antenna 2310 may be coupled to the radio front-end circuitry 2318 and may be any type of antenna capable of transmitting and receiving data and/or signals wirelessly. In certain embodiments, the antenna 2310 is separate from the network node 2300 and connectable to the network node 2300 through an interface or port.

The antenna 2310, communication interface 2306, and/or the processing circuitry 2302 may be configured to perform any receiving operations and/or certain obtaining operations described herein as being performed by the network node. Any information, data and/or signals may be received from a UE, another network node and/or any other network equipment. Similarly, the antenna 2310, the communication interface 2306, and/or the processing circuitry 2302 may be configured to perform any transmitting operations described herein as being performed by the network node. Any information, data and/or signals may be transmitted to a UE, another network node and/or any other network equipment.

The power source 2308 provides power to the various components of network node 2300 in a form suitable for the respective components (e.g., at a voltage and current level needed for each respective component). The power source 2308 may further comprise, or be coupled to, power management circuitry to supply the components of the network node 2300 with power for performing the functionality described herein. For example, the network node 2300 may be connectable to an external power source (e.g., the power grid, an electricity outlet) via an input circuitry or interface such as an electrical cable, whereby the external power source supplies power to power circuitry of the power source 2308. As a further example, the power source 2308 may comprise a source of power in the form of a battery or battery pack which is connected to, or integrated in, power circuitry. The battery may provide backup power should the external power source fail.

Embodiments of the network node 2300 may include additional components beyond those shown in FIG. 23 for providing certain aspects of the network node's functionality, including any of the functionality described herein and/or any functionality necessary to support the subject matter described herein. For example, the network node 2300 may include user interface equipment to allow input of information into the network node 2300 and to allow output of information from the network node 2300. This may allow a user to perform diagnostic, maintenance, repair, and other administrative functions for the network node 2300.

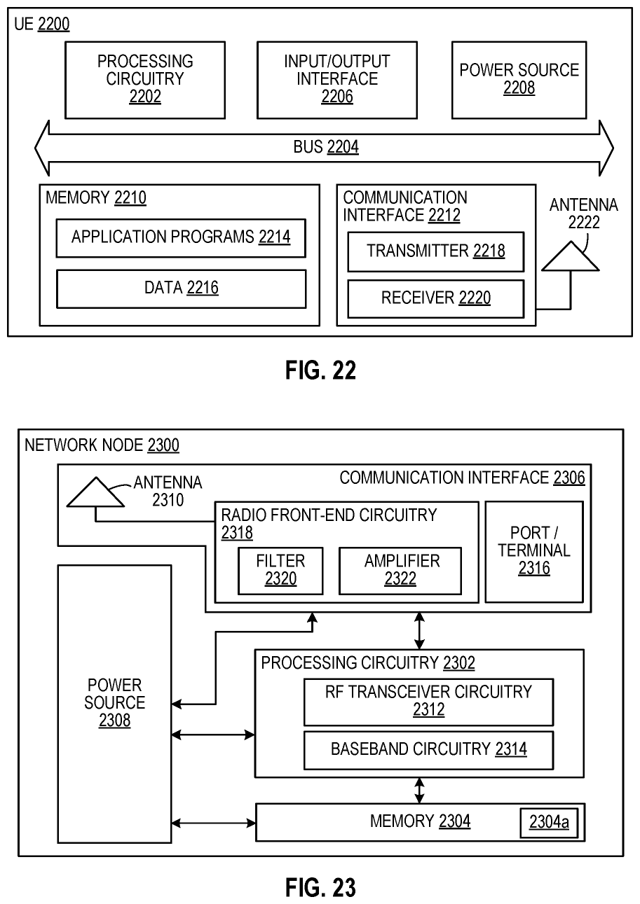

FIG. 24 is a block diagram of a host 2400, which may be an embodiment of the host 2116 of FIG. 21, in accordance with various aspects described herein. As used herein, the host 2400 may be or comprise various combinations hardware and/or software, including a standalone server, a blade server, a cloud-implemented server, a distributed server, a virtual machine, container, or processing resources in a server farm. The host 2400 may provide one or more services to one or more UEs.

The host 2400 includes processing circuitry 2402 that is operatively coupled via a bus 2404 to an input/output interface 2406, a network interface 2408, a power source 2410, and a memory 2412. Other components may be included in other embodiments. Features of these components may be substantially similar to those described with respect to the devices of previous figures, such as FIGS. 22 and 23, such that the descriptions thereof are generally applicable to the corresponding components of host 2400.

The memory 2412 may include one or more computer programs including one or more host application programs 2414 and data 2416, which may include user data, e.g., data generated by a UE for the host 2400 or data generated by the host 2400 for a UE. Embodiments of the host 2400 may utilize only a subset or all of the components shown. The host application programs 2414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2414 may also provide for user authentication and licensing checks and may periodically report health, routes, and content availability to a central node, such as a device in or on the edge of a core network. Accordingly, the host 2400 may select and/or indicate a different host for over-the-top services for a UE. The host application programs 2414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

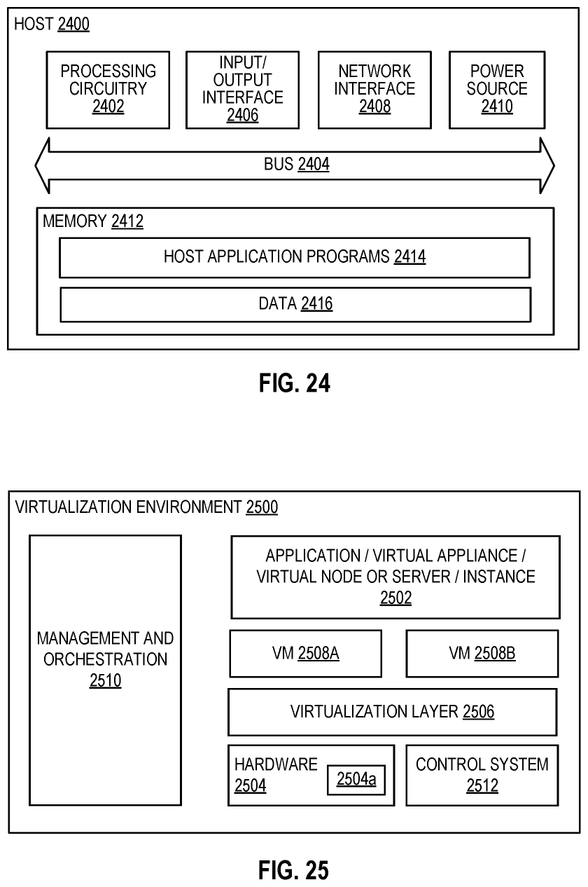

FIG. 25 is a block diagram illustrating a virtualization environment 2500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2502 (which may alternatively be called software instances, virtual appliances, network functions, virtual nodes, virtual network functions, etc.) are run in the virtualization environment 2500 to implement some of the features, functions, and/or benefits of some of the embodiments disclosed herein.

As more specific examples, different virtual network functions 2502 can be arranged to perform various operations of example methods (e.g., procedures) attributed to NSWOFs, AMFs, and AUSFs in the above description, including embodiments described in relation to FIGS. 18-20.

Hardware 2504 includes processing circuitry, memory that stores software and/or instructions (collectively denoted computer program product 2504a) executable by hardware processing circuitry, and/or other hardware devices as described herein, such as a network interface, input/output interface, and so forth. Software may be executed by the processing circuitry to instantiate one or more virtualization layers 2506 (also referred to as hypervisors or virtual machine monitors (VMMs)), provide VMs 2508a and 2508b (one or more of which may be generally referred to as VMs 2508), and/or perform any of the functions, features and/or benefits described in relation with some embodiments described herein. The virtualization layer 2506 may present a virtual operating platform that appears like networking hardware to the VMs 2508.

The VMs 2508 comprise virtual processing, virtual memory, virtual networking or interface and virtual storage, and may be run by a corresponding virtualization layer 2506. Different embodiments of the instance of a virtual appliance 2502 may be implemented on one or more of VMs 2508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2508 may be a software implementation of a physical machine that runs programs as if they were executing on a physical, non-virtualized machine. Each of the VMs 2508, and that part of hardware 2504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2508 on top of the hardware 2504 and corresponds to the application 2502.

Hardware 2504 may be implemented in a standalone network node with generic or specific components. Hardware 2504 may implement some functions via virtualization. Alternatively, hardware 2504 may be part of a larger cluster of hardware (e.g. such as in a data center or CPE) where many hardware nodes work together and are managed via management and orchestration 2510, which, among others, oversees lifecycle management of applications 2502. In some embodiments, hardware 2504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2512 which may alternatively be used for communication between hardware nodes and radio units.

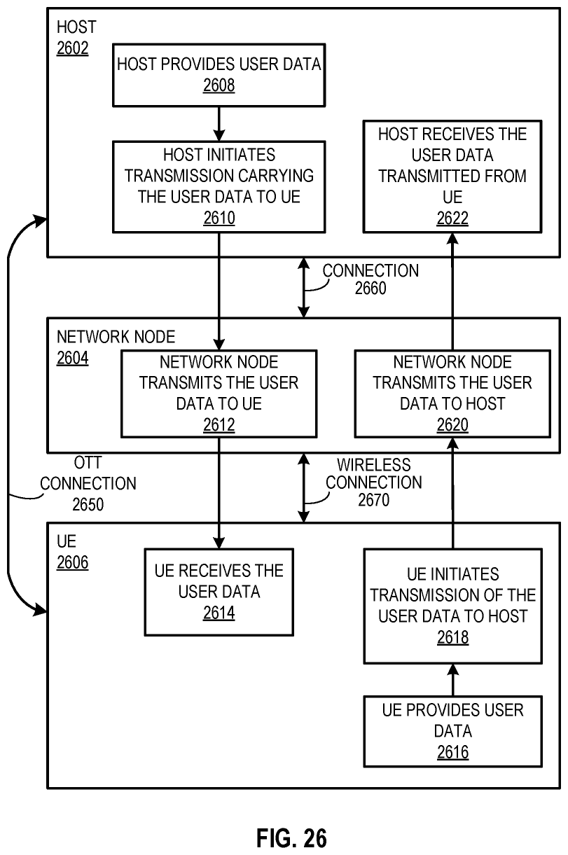

FIG. 26 shows a communication diagram of a host 2602 communicating via a network node 2604 with a UE 2606 over a partially wireless connection in accordance with some embodiments. Example implementations, in accordance with various embodiments, of the UE (such as a UE 2112a of FIG. 21 and/or UE 2200 of FIG. 22), network node (such as network node 2110a of FIG. 21 and/or network node 2300 of FIG. 23), and host (such as host 2116 of FIG. 21 and/or host 2400 of FIG. 24) discussed in the preceding paragraphs will now be described with reference to FIG. 26.

Like host 2400, embodiments of host 2602 include hardware, such as a communication interface, processing circuitry, and memory. The host 2602 also includes software, which is stored in or accessible by the host 2602 and executable by the processing circuitry. The software includes a host application that may be operable to provide a service to a remote user, such as the UE 2606 connecting via an over-the-top (OTT) connection 2650 extending between the UE 2606 and host 2602. In providing the service to the remote user, a host application may provide user data which is transmitted using the OTT connection 2650.

The network node 2604 includes hardware enabling it to communicate with the host 2602 and UE 2606. The connection 2660 may be direct or pass through a core network (like core network 2106 of FIG. 21) and/or one or more other intermediate networks, such as one or more public, private, or hosted networks. For example, an intermediate network may be a backbone network or the Internet.

The UE 2606 includes hardware and software, which is stored in or accessible by UE 2606 and executable by the UE's processing circuitry. The software includes a client application, such as a web browser or operator-specific “app” that may be operable to provide a service to a human or non-human user via UE 2606 with the support of the host 2602. In the host 2602, an executing host application may communicate with the executing client application via the OTT connection 2650 terminating at the UE 2606 and host 2602. In providing the service to the user, the UE's client application may receive request data from the host's host application and provide user data in response to the request data. The OTT connection 2650 may transfer both the request data and the user data. The UE's client application may interact with the user to generate the user data that it provides to the host application through the OTT connection 2650.

The OTT connection 2650 may extend via a connection 2660 between the host 2602 and the network node 2604 and via a wireless connection 2670 between the network node 2604 and the UE 2606 to provide the connection between the host 2602 and the UE 2606. The connection 2660 and wireless connection 2670, over which the OTT connection 2650 may be provided, have been drawn abstractly to illustrate the communication between the host 2602 and the UE 2606 via the network node 2604, without explicit reference to any intermediary devices and the precise routing of messages via these devices.

As an example of transmitting data via the OTT connection 2650, in step 2608, the host 2602 provides user data, which may be performed by executing a host application. In some embodiments, the user data is associated with a particular human user interacting with the UE 2606. In other embodiments, the user data is associated with a UE 2606 that shares data with the host 2602 without explicit human interaction. In step 2610, the host 2602 initiates a transmission carrying the user data towards the UE 2606. The host 2602 may initiate the transmission responsive to a request transmitted by the UE 2606. The request may be caused by human interaction with the UE 2606 or by operation of the client application executing on the UE 2606. The transmission may pass via the network node 2604, in accordance with the teachings of the embodiments described throughout this disclosure. Accordingly, in step 2612, the network node 2604 transmits to the UE 2606 the user data that was carried in the transmission that the host 2602 initiated, in accordance with the teachings of the embodiments described throughout this disclosure. In step 2614, the UE 2606 receives the user data carried in the transmission, which may be performed by a client application executed on the UE 2606 associated with the host application executed by the host 2602.

In some examples, the UE 2606 executes a client application which provides user data to the host 2602. The user data may be provided in reaction or response to the data received from the host 2602. Accordingly, in step 2616, the UE 2606 may provide user data, which may be performed by executing the client application. In providing the user data, the client application may further consider user input received from the user via an input/output interface of the UE 2606. Regardless of the specific manner in which the user data was provided, the UE 2606 initiates, in step 2618, transmission of the user data towards the host 2602 via the network node 2604. In step 2620, in accordance with the teachings of the embodiments described throughout this disclosure, the network node 2604 receives user data from the UE 2606 and initiates transmission of the received user data towards the host 2602. In step 2622, the host 2602 receives the user data carried in the transmission initiated by the UE 2606.

One or more of the various embodiments improve the performance of OTT services provided to the UE 2606 using the OTT connection 2650, in which the wireless connection 2670 forms the last segment. More precisely, embodiments described herein can provide various benefits and/or advantages useful for OTT services. For example, since only one authentication procedure is needed for a UE, this can reduce the signaling between UE and involved network entities (and among network entities), as well as processing load in UE and involved network entities, relative to conventional techniques that require two authentication procedures.

Additionally, embodiments facilitate reduced delay when a UE registers to non-3GPP access network since the UE's security context is already available from earlier registration with 5GC. By reducing registration delay for users and network signaling/processing resources needed for registration, embodiments improve the delivery of OTT services via a network, thereby increasing the value of OTT services to end users and service providers.

In an example scenario, factory status information may be collected and analyzed by the host 2602. As another example, the host 2602 may process audio and video data which may have been retrieved from a UE for use in creating maps. As another example, the host 2602 may collect and analyze real-time data to assist in controlling vehicle congestion (e.g., controlling traffic lights). As another example, the host 2602 may store surveillance video uploaded by a UE. As another example, the host 2602 may store or control access to media content such as video, audio, VR or AR which it can broadcast, multicast or unicast to UEs. As other examples, the host 2602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2650 between the host 2602 and UE 2606, in response to variations in the measurement results. The measurement procedure and/or the network functionality for reconfiguring the OTT connection may be implemented in software and hardware of the host 2602 and/or UE 2606. In some embodiments, sensors (not shown) may be deployed in or in association with other devices through which the OTT connection 2650 passes; the sensors may participate in the measurement procedure by supplying values of the monitored quantities exemplified above, or supplying values of other physical quantities from which software may compute or estimate the monitored quantities. The reconfiguring of the OTT connection 2650 may include message format, retransmission settings, preferred routing etc. ; the reconfiguring need not directly alter the operation of the network node 2604. Such procedures and functionalities may be known and practiced in the art. In certain embodiments, measurements may involve proprietary UE signaling that facilitates measurements of throughput, propagation times, latency and the like, by the host 2602. The measurements may be implemented in that software causes messages to be transmitted, in particular empty or ‘dummy’ messages, using the OTT connection 2650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1-44. (canceled)

45. A method for a user equipment (UE) configured to communicate with a communication network via a wireless local access network (WLAN), the method comprising:
performing an authentication with the communication network, including obtaining an identifier associated with user credentials on which the authentication is based;
subsequently sending, to the WLAN, a request for authorization to connect to the WLAN, wherein the request for authorization includes the identifier, wherein the identifier points to or will be routed to a WLAN offload function;
receiving, from the communication network via the WLAN, an authorization to connect to the WLAN, wherein the authorization is based on the identifier; and
establishing a secure connection with the WLAN based on the received authorization.

46. The method of claim 45, wherein performing an authentication with the communication network includes or is followed by deriving one or more security keys based on the user credentials.

47. The method of claim 46, wherein establishing a secure connection with the WLAN comprises:
deriving a further key based on one of the derived security keys, wherein the further key is a master session key (MSK) or another key; and
using the further key to establish the secure connection with the WLAN.

48. The method of claim 46, wherein the identifier associated with user credentials is one of the following: a temporary UE identifier assigned by the communication network, a security key identifier derived by the UE, or a concealed identifier of a user subscription to the communication network.

49. The method of claim 48, wherein one or more of the following applies:
the request for authorization includes a UE reauthorization indicator;
the temporary UE identifier is a 5G global unique temporary identifier (GUTI), the security key identifier derived by the UE is a Kausf ID, and the concealed identifier is a subscription concealed identifier (SUCI);
obtaining the identifier associated with user credentials comprises deriving the security key identifier from one of the derived security keys; or
the temporary UE identifier is associated with or contained in a protocol data unit that is integrity-protected based on the user credentials.

50. The method of claim 48, further comprising:
in response to the request for authorization, receiving an authentication request from the communication network via the WLAN; and
sending an authentication response to the communication network via the WLAN,
wherein the authorization to connect is received in response to the authentication response.

51. The method of claim 50, wherein the authentication response includes the temporary UE identifier.

52. The method of claim 50, wherein:
the authentication request includes an identifier of an authentication method or algorithm; and
the method further comprises calculating the authentication response based on the following: one of the derived security keys, and the identified authentication method or algorithm.

53. A method for a wireless LAN (WLAN) offload function associated with a communication network, the method:
receiving, from a user equipment (UE) via a WLAN, a request for authorization for the UE to connect to the WLAN, wherein the request for authorization includes an identifier associated with user credentials for the communication network;
sending, to a network node or function (NNF) of the communication network, a request for UE authentication that includes the identifier or a representation thereof;
receiving, from the NNF, an authorization for the UE to connect to the WLAN, wherein the authorization is based on the identifier; and
forwarding the authorization to the WLAN and to the UE via the WLAN.

54. The method of claim 53, wherein:
the authorization for the UE to connect to the WLAN is received together with a further key for securing a connection between the UE and the WLAN, wherein the further key is a master session key (MSK) or another key; and
the further key is sent to the WLAN together with the authorization for the UE to connect.

55. The method of claim 53, wherein:
the identifier received in the request for authorization is a temporary UE identifier; and
the method further comprises, based on the received temporary UE identifier, deriving or determining a permanent identifier of a user subscription to the communication network, wherein the permanent identifier is sent in or with the request for UE authentication.

56. The method of claim 53, further comprising:
in response to the request for UE authentication, receiving from the NNF a first response that includes an authentication request for the UE and an identifier of an authentication method or algorithm;
forwarding the authentication request and the identifier of the authentication method or algorithm to the UE via the WLAN;
receiving an authentication response from the UE via WLAN; and
forwarding the authentication response to the NNF,
wherein the authorization for the UE to connect to the WLAN is received in response to the forwarded authentication response.

57. The method of claim 53, wherein one of the following applies:
the NNF is an access and mobility management function (AMF); or
the NNF is an authentication support function (AUSF) and the request for UE authentication also includes one or more of the following: a non-seamless WLAN offload (NSWO) indicator, and a UE reauthentication indicator.

58. A method for an access and mobility management function (AMF) of a communication network, the method comprising:
receiving, from a non-seamless wireless LAN (WLAN) offload function (NSWOF) associated with the communication network, a request for authorization of a user equipment (UE) for access to a WLAN, wherein the request includes an identifier associated with user credentials for the communication network;
based on the identifier, discovering a valid UE security context stored in the communication network; and
based on the discovered UE security context, sending to the NSWOF an authorization for the UE to connect to the WLAN.

59. The method of claim 58, further comprising:
calculating a UE authentication response based on the following: the discovered UE security context, and an authentication method or algorithm selected for authenticating the UE;
sending to the NSWOF a response that includes an authentication request for the UE and an identifier of the authentication method or algorithm;
receiving an authentication response from the UE via the NSWOF; and
determining whether the authentication response from the UE matches the calculated UE authentication response,
wherein the authorization for the UE to connect to the WLAN is sent based on determining that the authentication response from the UE matches the calculated UE authentication response.

60. The method of claim 59, wherein:
the method further comprises, based on verifying the integrity of the PDU or determining a match of the authentication response, deriving a master session key (MSK) or another key for securing a connection between the UE and the WLAN, based on one or more security keys in the UE security context; and
the MSK is sent to the NSWOF together with the authorization for the UE to connect to the WLAN.

61. A method for an authentication server function (AUSF) associated with a communication network, the method comprising:
receiving, from a non-seamless wireless LAN (WLAN) offload function (NSWOF) associated with the communication network, a request for authorization of a user equipment (UE) for access to a WLAN, wherein the request includes an identifier associated with user credentials for the communication network;
based on the identifier, discovering a valid UE security key stored in the communication network; and
based on the discovered UE security key, sending to the NSWOF an authorization for the UE to connect to the WLAN.

62. The method of claim 61, wherein one of the following applies:
the identifier included in the request is a security key identifier derived by the UE and discovering a valid UE security key comprises detecting a match between the security key identifier derived by the UE and a corresponding identifier of the valid UE security key stored in the communication network; or
the identifier included in the request is one of the following: a permanent identifier of a user subscription to the communication network, or a concealed identifier of a user subscription to the communication network.

63. The method of claim 61, further comprising:
selecting an authentication method or algorithm to be used for authenticating the UE;
calculating a UE authentication response based on the UE security key and on the selected authentication method or algorithm;
sending to the NSWOF a response that includes an authentication request for the UE and an identifier of the authentication method or algorithm;
receiving an authentication response from the UE via the NSWOF; and
determining whether the authentication response from the UE matches the calculated UE authentication response,
wherein the authorization for the UE to connect to the WLAN is sent based on determining that the authentication response from the UE matches the calculated UE authentication response.

64. The method of claim 63, wherein:
the method further comprises, based on determining that the authentication response from the UE matches the calculated UE authentication response, deriving a master session key (MSK) for securing a connection between the UE and the WLAN;
the MSK is derived based on one or more security keys in the UE security context; and
the MSK is sent to the NSWOF together with the authorization for the UE to connect to the WLAN.
